(19) United States
(12) Patent Application Publication
(10) Pub. No.: US 2014/0214473 A1
(43) Pub. Date: Jul. 31, 2014

(54) METHOD AND SYSTEM FOR PROVIDING ENHANCED SALES AND MARKETING TOOL

(71) Applicants: Carl Gentile, Dallas, TX (US); Gareth Raab, Coppell, TX (US)

(72) Inventors: Carl Gentile, Dallas, TX (US); Gareth Raab, Coppell, TX (US)

(21) Appl. No.: 13/926,503

(22) Filed: Jun. 25, 2013

Related U.S. Application Data
(63) Continuation of application No. 13/754,420, filed on Jan. 30, 2013, now abandoned.

(51) Int. Cl. G06Q 10/06; G06Q 50/08

(52) U.S. Cl. CPC G06Q 10/06313; G06Q 50/08
USPC 705/7.23

(57) ABSTRACT

An integrated system assists sales professionals in preparing for and presenting sales demonstrations and in capturing project-specific data for use in quoting projects in real-time. A central server-side computer-based system is used with remote client-side applications. A Sales “Walk About” Tool (“SWAT”) includes visualization functionality and data capture routine(s) implemented using a mobile user-client device as an effective mobile sales tool. The SWAT system assigns projects, tracks sales efforts, captures data, schedules sales calls and coordinates installation.

### CROSS-REFERENCE TO RELATED APPLICATION

The present application claims benefit of priority to and is a continuation of U.S. patent application Ser. No. 13/754,420, filed Jan. 30, 2013, and entitled METHOD AND SYSTEM FOR PROVIDING ENHANCED SALES AND MARKETING TOOL (Gentile et. al.), which is hereby incorporated by reference herein in its entirety.

### FIELD OF THE INVENTION

The invention generally relates to methods and systems for providing enhanced sales and marketing materials and tools, particularly related to building products or elements (e.g., windows, decks, siding roofing, gutters, cabinets, lighting, entry doors, interior doors, etc. including replacement products) for use in construction and building/home improvement projects. More specifically, the invention relates to providing building product manufacturers and retail/installation dealers and distributors and related sales forces tools to effectively configure, show/demonstrate and visualize building products and in particular doing so in the context of the prospective purchaser's home/building.

### BACKGROUND OF THE INVENTION

Building products or elements include products used in constructing/remodeling buildings, including non-residential commercial buildings, governmental buildings, and residential or home (single family and multi-family) buildings. Selection of materials and options offered in manufactured building products is critical in the delivery of an aesthetically pleasing and satisfying improvement or project and often determines or affects the cost of the products and the project. The building products industry represents a long standing industry directed to manufacturing, delivering, and installing architectural products or elements, e.g., windows, fenestration appurtenances, doors, hardware, etc., including millwork and aluminum or other extruded products. In the past, salespersons have been largely confined to presenting product fragments, print (glossy) brochures and even more recently static pdf images of brochures to customers during in-home, face-to-face, counter, or other retail interactions. There are several problems with these types of sales presentations. First, often it is difficult or impossible to present brochures adequately representing all product lines and all variations and options associated with such product lines. Second, the salesperson cannot effectively demonstrate how the various product types, colors, etc. will actually look after construction or replacement on the customer's building. Many people have difficulty “visualizing” how building elements will look on a building when replacing existing elements. Third, the salesperson cannot seamlessly and effectively generate “firm” quotes (an offer as opposed to “ball park” estimates), especially on-site during a sales call, reflecting and tied to the various options and selections desired for consideration by the customer. Fourth, because of the above, the salesperson is disadvantaged in being able to “close the deal” with the customer during that initial or early sales call or demonstration. Data and reports have shown that if a salesperson does not close a deal or sign a contract with a business owner at the time of the sales call the likelihood of making the sale drops substantially. What is needed is a tool that will help the salesperson present all the information needed to the customer to enable the customer to make a decision at the time of the sales call and close the deal while on site. What is needed is a sales tool that effectively and accurately presents and “visualizes” the project so that once installed the customer is satisfied that the end product is consistent with the sales call presentation.

In the context of the description contained herein, processes may be described in the context of manufacturers, customers, dealers, contractors, and homeowners/business owners. In the context of a manufacturer, a dealer or contractor may be a direct customer, while a homeowner or business owner, for instance, would be a direct customer to the dealer or contractor and an indirect or secondary-tier customer to the manufacturer. For instance the homeowner/business owner is really the homeowner or business owner or ultimate decision maker for the improvement project. An improvement project may include a replacement of existing building products (e.g., windows, doors, siding, roof, and gutters), an addition to an existing structure, a new structure, a renovation, etc.

Building product or element manufacturers face many challenges in making product information readily available to their dealers, sales force, installers and end-consumers and in providing their dealers/contractors with effective sales tools and support. In particular, sales representatives involved in in-home sales calls directly interacting with home or business owners need a more effective way to receive and manage information related to products and projects, to present sales related information to prospective customers, to capture data needed in generating firm quotes to customers, and to “close the deal” on-site in culmination of the sales call. A further problem faced by dealers and contractors is providing the home/business owner with a representative visual representation (“visualization”) of the final configured product or completed improvement project. Yet another problem faced by installers and field technicians is that they are not able to easily retrieve accurate project data, including measurement data, and product specific installation instructions during installation or repair.

What is needed is a system that allows for easy capturing, tracking and retrieval of information pertaining to a specific customer/project, data captured as part of the sales call process, including measurement data, visualization of presented product offerings, and firm quotes generated during the sales call. A system is needed that allows manufactures, dealer/contractors, installers, field technicians, customer service representatives, and end-user/customers to access critical project data.

What is also needed is a system that captures data from other public sources (i.e. Zillow) and correlates all data into a single view for all members of the sales/installation chain.

### SUMMARY OF THE INVENTION

The present invention provides an integrated system that assists sales professionals in preparing for and presenting sales demonstrations and in capturing customer-specific data for use in successfully closing a sales call and subsequently in tracking customer installation and other activities. The invention enables the dealer/contractor, the manufacturer and the home owner to supply information into a single system and present project data (e.g., product data, pricing, and visualization) back to the appropriate person in the sales chain. For example: the dealer/contractor gets information about the sales call; historical sales call performance; project status; sales process efficiencies and eventually the electronic order. The salesperson receives information related to leads, contacts, appointments and sales material delivered to the salesperson's remote device (e.g., iPad, tablet, or other remote device); the homeowner gets quote-specific information; a visual representation of the product; a visual representation of the home with the installed product and the ability to share the project on social media. The manufacturer gets market data from the sales calls and dealer/contractors who perform better than the competition (increased sales) and dealer/contractors that are tied into the tool (again loyal dealers and increased sales).

The invention includes central server-side computer-based systems and a centralized relational database to capture and consolidate information and local or remote client-side applications to assist the in-home or other salesperson in sales presentation and in improving the sales process. Further, the invention may be implemented by way of an external kiosk or store-front (counter) retail operation. In one embodiment the invention includes a Sales “WalkAbout” Tool (“SWAT”) that includes visualization functionality and project management and data capture routines as part of a client-side application (locally stored and executed or optionally via online access) having a user interface. The SWAT tool includes electronic sales collateral materials (e.g., brochures) that can be emailed real-time to the homeowner. The SWAT may be implemented using a mobile user-client device such as an iPad or other tablet, smart phone, laptop, or other such device, to provide an effective mobile sales tool to salespersons/users.

From the dealer/installer perspective, the invention is useful in assigning projects to sales employees, tracking open sales efforts, and captures data useful in tracking and scheduling projects, evaluating relative effectiveness of sales techniques. From the manufacturer perspective, the invention captures data useful in tracking projects, evaluating relative effectiveness of products and sales techniques, which may be analyzed at geographic, socio-economic and other levels. The invention may also prove useful in the context of warranty, follow-up, post-project sales calls and other uses. The invention may provide a customer portal or other access or interface means for a customer/user to access project information in an in-home environment and share the project plans and results through social media.

In one manner, the invention may be used in a retail operation by way of an application in a storefront kiosk or Internet site or other sales tool designed to give dealers or retailers an advantage in competing for a home owner's business. In this example, the dealer in the storefront could show the home improvement project/products on/in the home to allow the homeowner to visualize the improvement. The invention allows for further processes and customization, e.g., through rasterization of building owner supplied photos of the building and the like, because there will be time between the storefront visit and the actual in-home sales call to process the picture to provide the on-home visualization to work.

As used herein, rasterisation or rasterization refers to the process or task of taking an image, such as a photograph, described in a vector graphics format (shapes) and converting it into a raster image (pixels or dots) for output on a video display or printer, or for storage in a bitmap file format and to more generally electronically preparing an image to better incorporate customized elements, e.g., placing image elements over or in place of other elements in a photo in a layered fashion whereby objects or image elements appearing in the image retain context. For example, a photo of a home having windows and a tree in the front yard of the house that partially obscures or blocks part of the window behind the tree. When digitally replacing the existing window with an image of a prospective replacement window the rasterized image retains the relative positioning of the tree relative to the window and house, i.e., in front of the window.

In carrying out the invention, the SWAT system architecture may be deployed in an environment that includes a manufacturer, distributor/retailer customer, and end-user customer (i.e., home or building owner)—essentially three actors. The dealer/contractor makes sales calls and configures the products to the building owner's specifications. The customized material is then ordered from the manufacturer. The dealer/contractor receives the material from the manufacturer and installs it in the building. The invention is described in terms of home products such as windows, doors and other building products, but may be implemented for beneficial use in a variety of environments.

For example, Atrium Corporation (“Atrium”) is a manufacturer and supplier of products including windows and other products. Direct customers of Atrium and other manufacturers include dealers who separately contract with home and business owners for the installation of home building products, including windows, doors, etc. Preferably, the invention is implemented so that the dealer uses only the manufacturer's application on the manufacturer's central server. The manufacturer's application adds significant value to both the dealer and the manufacturer. It allows the dealer to enter their information that is then combined into a single repository. The manufacturer's central server then coordinates the data transfer between the remote device and the server. This allows the salesperson to get all relevant data and then add the data from the homeowner from the sales call. In this preferred embodiment, the manufacturer also receives valuable sales information about its products from the dealer and related to the end-user customer.

The invention may also be implemented in a three-party manner with manufacturer providing one central server and the dealer/contractor providing a second central server that interfaces directly with sales personnel equipment and/or the end-user customer client device such as over a network, e.g., the Internet. One or both central servers may include or be connected to databases, such as product databases and/or project databases. Where a manufacturer also has an installation and branch office structure for direct interaction and contracting with end user customers the middle or dealer component may not be present. The invention may be beneficially implemented in a variety of environments and the particular interactions are not limiting to the invention.

In one example, a Manufacturer, such as Atrium, has an “Administration” central server system including an application internal to Manufacturer. The central server may receive information related to potential sales calls and customers and may facilitate Manufacturer's dealers by assisting in selling Manufacturer building products to end-user customers. Among other things, the central server may: enable dealer/contractor access to the Sales Walk About Tool (“SWAT”); assign dealer/contractors to certain products; assign dealer/contractors to internal financial information; set list prices (time phased); manage literature for products; add dealer/contractor specific or tailored literature; and inactivate customers. In addition, other activities may include: coordinate software and data updates; process visualization such as layering the pictures elements (e.g., RenoWorks); support customer administrators such as through chat, telephone or other remote means; provide dealer/contractor/customer support; seed default values (rooms). The manufacturer provides data backup and recovery (in case the device is lost or damaged) and historical reporting for sales analysis by the dealer/contractor. The central application can also move projects/leads between sales personnel to help the dealer/contractor manage workloads between sales personnel.

The system may include a Customer Administration module, which may be a “back office” function, capable of the following: being used by dealer/contractor and supported by the manufacturer; dealer/contractor can assign, track and manage sales leads and sales force and distribute leads and sales calls to sales force and devices, e.g., salesperson iPad or tablet devices; dealer/contractor can terminate access to project and sales information at the salesperson/device level; manage use of discounts, e.g., set and override prices or discount percentages, to avoid unauthorized “in-home” commitments to pricing and discounts; uniformly distribute product and company sales and installation literature to sales staff and installation staff or dealer/contractors; co-branding of manufacturer SWAT tool with dealer/contractor—helps strengthen dealer ties to manufacturer and to products and services as often dealers may represent multiple manufacturers across product lines; facilitates capture of project and home-owner information; integrates end-user home-owner customer with the sales, quote and installation process making for a more customized and personalized presentation and process; provides end-user customer access to project information; facilitates real-time sales call data capture and quote generation to help close the deal and sign a contract at an earlier stage of the sales cycle leading to higher success rates; seamlessly integrates sales effort with management of project including ordering, scheduling and installation; and integrates third-party solutions and allows for pre-work activity (e.g., integrate Zillow data into project profile to get a head start on the sales process). Additional functions that the Administration module may perform include: manage sales force calendars (e.g., Outlook, iCal); view sales force calendar and contact data; and develop portfolio book for use in sales calls.

From the sales force perspective, the SWAT provides a highly effective in-home sales presentation tool enhancing, for example, the following tasks common to sales efforts: update project and home owner information; ability to set deal discounts and request for override authorization; ability to quickly and accurately collect key condition, product type, location and measurement information; present up-sell options and efficiently generate and deliver multiple scenarios and quotes; build enhancement options, e.g., combination window upgrades; synchronize projects with CRM and other functions; generate emails with project/product information, e.g., product selection and features, quotes, etc.; manage and present product and company literature; manage and build portfolio presentations; and provide a social media interface to allow sharing of ideas between the home owner's friends and families and review project details after the sales call has been completed.

One objective or goal of the invention is to place a mobile (e.g., notebook computer, or tablet-based device) tool in the hands of in-home or on-site salespersons that is highly effective and in promoting successful sales calls and orders. The SWAT tool allows a dealer/contractor to produce a professional sales presentation coupled with highly accurate and reliable quoting tools for dynamic “real-time” delivery to the homeowner on the day of the sales call. The tool will present information about the products, show reference work and/or testimonials, and execute a contract and collect a down payment. By improving the overall sales experience for the homeowner the invention will increase a manufacturer's sales of manufactured building products, e.g., replacement doors and windows (or other related home improvement products). The sales battle is most often won/lost in the home (and more specifically at the kitchen table). Key capabilities of the present invention sales tool include: ease of use for the in-home salesperson and customer; preferably runs on a variety of tablet and other mobile device platforms (e.g., iPad); integrates with product configurator and visualizer solutions using established rules, constraints or option lists—see discussion below; takes advantage of the many apps that come with tablets; supports manufacturer and dealer/contractor pricing and up-selling; controls quote and configuration and/or product offerings (e.g., a manufacturer providing the tool to its dealer/contractors can restrict use of the tool to its own products and not allow the dealer/contractor to use the visualization and quoting tools for use with competitor products); preferably capable of running on either or both a connected basis and a stand-alone (disconnected) basis; orders created through the sales process support orders from the dealer's customer (end-user) and should flow through distributor to manufacturer; and enables manufacturer to capture in-home sales information about its products across its network of dealers.

Using the visualization aspect of the invention, the salesperson can provide a visualization of the prospective purchaser's building with the replacement or proposed products offered by the salesperson. The invention allows salespersons to easily visualize/customize while in front of the homeowner. In addition, the invention consolidates data from multiple sources into a seamless tool. In the context of a renovation or replacement project, the invention enables the salesperson to provide the purchaser with a “before and after” comparison before the “after” has even occurred. In this way the purchaser better understands how the building will look following installation further enhancing customer satisfaction and loyalty. Further, by presenting a dynamic visualization of the project, the salesperson can use the tool to modify the project based on changes in selection, e.g., window type, grid type, color, shape, etc., by the customer to better present options available to the customer. In addition, the salesperson can generate a series of firm quotes representing the various scenarios to enable the customer to weigh cost with degree of satisfaction. In this manner the tool helps insure a heightened customer experience and resulting satisfaction rate.

The invention supports the entire sales cycle from lead generation data collected and/or input. Lead data may come from one or many sources, e.g., mail campaigns, canvassing, home shows, Internet leads, etc. These leads would be input and received into the central application. The tool supports manufacturer sales through a dealer/contractor network, dealer/contractor in-home sales efforts. The tool may also support manufacturer sales, dealer/distributor sales and supports business functions for builders, dealer/distributor, customer service, EDI. The tool preferably uses a consolidated data model comprising or integrating among one or more databases, e.g., configuration data, quote/order data, customer data, project data, and manufacturing/product data.

The tool may provide a customer portal for access to order status, scheduling, installation, warranty and other aspects of the post sales process. For the salesperson and the contractor/dealer the tool includes functionality such as: manage contacts/leads; manage time/appointments; create and manage project portfolio and testimonials; download and manage product information—brochures and capabilities; enable salesperson to design project elements (e.g., options and upgrades related to replacement building products) at the table using visualization. For example, in the context of presenting and quoting a customer for window replacement project, a salesperson may use the tool to: present background on windows; present portfolio of projects; present information about the replacement window products and the dealer/contractor; capture building specific data. The salesperson can use the tool to design window configuration and functions interactively with the homeowner (homeowner-homeowner or business owner or decision-maker) while “at the table” in the home or business. Examples of design features and parameters supported by the invention include: product quality (good, better, best); grid patterns; product type/style; energy efficiency; double strength glass; hardware and product color. The tool enables the salesperson to generate firm quotes for consideration and agreement by the home owner. In this manner the invention enables the salesperson to sell the home owner at the most opportune time/place (e.g., selling an entry door in front of the home; selling a window in front of the current window; selling granite counter tops in the kitchen).

In one manner, the invention may be used to enable significant “pre-work” to better inform the salesperson of important sales issues concerning the potential customer/home owner. For example, the invention can help prepare sales people for sales calls by providing information about the neighborhood, the type/style/age of home, the home owner, etc. Existing solutions such as Zillow may be used to help the pre-work preparation. Zillow is a real estate application that will help the in-home salesperson understand the neighborhood. The invention sales tool may be used to access Zillow and other resources to help with understanding the home subject to the sales call. Information such as age; pictures; and ownership may be obtained. When the salesperson arrives at the home he would take a picture(s) of the home to use in the sales process. This could include the exterior surface to help with visualization. In some instances photos may be obtained in advance of the sales call so the dealer/contractor could show the house with the configured windows. For instance, in a drive-by photos may be taken and rasterized so that replacement windows can be visualized on the existing home and may be presented during the sales call to help the home owner better understand how the replacement windows or other products will actually look once installed. Better visualization leads to higher success rates for both sales and for home/building owner satisfaction.

During the sales call, the salesperson sets up camp (usually at the kitchen table) with the sales tool running on the mobile device along with any “hard” window samples brought to the sales call. At the kitchen table the invention sales tool includes a teaching or tutorial function (e.g., “Window University”) to assist the salesperson to: discuss his company (dealer/contractor); discuss and demonstrate window technology and options generally and specifically to the brand/products offered; discuss and demonstrate similar jobs (portfolio) and references; determine window/baseline configurations or designs related to the house call (e.g., series; type; energy efficiency, color; glass package; etc.); and demonstrate the product and collateral materials.

Next, the salesperson surveys or “walks about” the house to determine the scope of the project and any possible upgrades or options to present to the customer/homeowner. The invention sales tool provides an enhanced experience for the salesperson and, more importantly, for the customer/homeowner to better envision the end result of the project. For example, the sales tool of the invention provides a visualization to better up-sell the home owner on the following exemplary scenarios: “Have you ever thought about replacing the two double hung windows with a bay window?”; “With all of this wood trim, would you be interested in upgrading the interior surface?”; “How about obscure glass in the bathroom?”; “This is a perfect spot for a garden window”; “This glass will have to be tempered”; “What a beautiful view—I think a picture window without grids would be perfect”; “This southern exposure should really have super low E.” The inventive sales tool enables users to define and present special configurations (shapes, combo units, surcharges, non-window products).

Next, the salesperson returns to the Kitchen Table with the owner and endeavors to close the sale. The invention sales tool helps the salesperson to: discuss results of the survey—scope of the project and condition of existing windows; design the solution by configuring the product; discuss options/features; show similar work (portfolio); discuss pricing (MSRP) with discounts; generate and produce quotes related to the project; provide firm quotes modifiable to reflect available upgrades and options and alternative phases or scenarios; and execute the contract in the home at the kitchen table (electronic signature function). Alternatively, the tool may enable the salesperson to send the proposal to a social media site for sharing with friends and family.

In a first embodiment, the present invention provides a computer-implemented method for dynamically capturing project data and presenting visualization to a customer using a mobile computing device during an on-site sales visit, the visualization related to captured project data and a prospective building improvement, the method comprising: inputting data representing a description of building elements existing in a building using a user interface operating on the mobile computing device during an on-site survey of the building; storing the input data on the mobile computing device and associating the stored data with a unique project record; generating and presenting a set of one or more visualization images via a display associated with the mobile computing device, the set of one or more visualization images representing a prospective building improvement related at least in part to replacement of one or more existing building elements; and temporally proximate to the on-site survey, generating on-site a firm quotation related to the building improvement and to replacement of one or more existing building elements.

In a second embodiment, the invention provides a computer-based system comprising: a central server having a processor for executing instructions, a memory for storing instructions, a database containing information related to replacement products or building improvement services, and a communications interface for communicating remotely with field deployed machines; a mobile computing device having a processor for executing instructions, a memory for storing instructions and data, a display for presenting information, and a user interface for processing inputs related to displayed information, the mobile computing device having a communications interface for connecting remotely with the central server via a communications network; and a sales walk about tool (SWAT) comprising instructions when executed by the mobile computing device processor adapted to: present a user interface for receiving a set of survey input data representing a description of building elements existing in a building during an on-site survey of the building; store the set of survey input data on the mobile computing device memory and associate the stored data with a unique project record; and generate a firm quotation related to providing services or replacement products corresponding to the existing building elements.

In addition the invention may be further characterized as follows: having an input adapted to receive lead information related to a potential sale; and an output adapted to transmit a signal over a communications network to the mobile computing device, the signal related to the received lead information and an assigned unique identifier and associated unique project record; wherein the sales walk about tool (SWAT) comprises instructions when executed by the mobile computing device processor adapted to execute an agreement and record an executed agreement related to providing a set of replacement products corresponding to the one or more existing building elements; having means for generating and transmitting an electronic communication comprising content related to replacement products corresponding to the building improvement; having instructions when executed by the mobile computing device processor adapted to generate a graphical representation of a building associated with the building improvement and existing building elements; wherein the set of one or more visualization images comprises a rasterized image representing an aspect of the customer building combined with a set of one or more replacement products; wherein the set of one or more visualization images comprises at least one of a floating image or an anchored image of a replacement product selected as a prospective replacement for one or more existing building elements; having means for automatically modifying the at least one of a floating image or an anchored image to reflect a user selection altering an aspect of the replacement product; wherein the firm quotation relates to a first cost associated with the building improvement and further comprising means for generating at least one other firm quotation representing a second cost associated with the building improvement and based on a modification of replacement products; having means for presenting a default set of parameters related to building elements for use in inputting data, the default set of sizes related to previously input data representing a description of building elements existing in a building using during the on-site survey of the building; having means for making the set of one or more visualization images related to the building improvement accessible for display via one or more social media sites; having means for processing an electronic payment during the on-site sales visit as payment related to the building improvement; having means for presenting information pertaining to the building improvement during the on-site sales visit, the presented information comprising one or more of the following: educational information relating to replacement building products for use in the building improvement; educational information about product performance characteristics; information about savings or other benefits associated with building products and/or potential payback data; information pertaining to the dealer/contractor and/or installer involved in the building improvement; information pertaining to a sales pitch book; information pertaining to product comparisons; and information pertaining to financing options relating to the building improvement.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a schematic network diagram of the components involved in the inventive SWAT tool and system.

FIG. 2 is a schematic network diagram of an alternative implementation of the inventive SWAT tool and system.

FIG. 3 is a flowchart of the steps involved in one embodiment of a method associated with the SWAT tool.

FIG. 4 is a flowchart of the steps involved in an alternative embodiment of a method associated with the SWAT tool.

FIG. 5 is a detailed data-flow and process diagram depicting system components and actions with flow of data between the components in carrying out the method associated with the SWAT tool.

FIG. 6 is a screenshot of a user interface associated with the Projects management aspect of the inventive SWAT tool.

FIG. 7 is a screenshot of a user interface associated with the Project Details management aspect of the inventive SWAT tool.

FIG. 8 is a screenshot of a further user interface associated with the Project Details management aspect of the inventive SWAT tool.

FIG. 9 is a screenshot of a user interface associated with the Window University aspect of the inventive SWAT tool.

FIG. 10 is a screenshot of a user interface associated with the Walking About or survey and data capture aspect of the inventive SWAT tool.

FIG. 11A is a screenshot of a further user interface associated with the Walking About or survey and data capture management aspect of the inventive SWAT tool.

FIG. 11B is a screenshot of a yet a further user interface associated with the Walking About or survey and data capture management aspect of the inventive SWAT tool.

FIG. 12 is a screenshot of a user interface associated with the Detailed Window Entry aspect of the inventive SWAT tool.

FIG. 13 is a screenshot of a further user interface associated with the Detailed Window Entry aspect of the inventive SWAT tool.

FIG. 14 is a screenshot of a further user interface associated with the Other window types aspect of the Detailed Window Entry aspect of the inventive SWAT tool.

FIG. 15 is a screenshot of a further user interface associated with the Shapes aspect of the Detailed Window Entry aspect of the inventive SWAT tool.

FIG. 16 is a screenshot of a further user interface associated with the Combos aspect of the Detailed Window Entry aspect of the inventive SWAT tool.

FIG. 17 is a screenshot of a further user interface associated with the Detailed Window Entry aspect of the inventive SWAT tool.

FIG. 18 is a screenshot of a user interface associated with the Customizer aspect of the Detailed Window Entry aspect of the inventive SWAT tool.

FIG. 19 is a screenshot of a further user interface associated with the Floating Visualization aspect of the Detailed Window Entry aspect of the inventive SWAT tool.

FIG. 20 is a screenshot of a further user interface associated with the Anchored Visualization aspect of the Detailed Window Entry aspect of the inventive SWAT tool.

FIG. 21 is a screenshot of a user interface associated with the Review WalkAbout aspect of the inventive SWAT tool.

FIG. 22 is a screenshot of a further user interface associated with the Review WalkAbout aspect of the inventive SWAT tool.

FIG. 23 is a screenshot of a user interface associated with the Design Studio aspect of the inventive SWAT tool.

FIG. 24 is a screenshot of a user interface associated with the Quotes aspect of the inventive SWAT tool.

FIG. 25 is a screenshot of a user interface associated with the Quote Details aspect of the inventive SWAT tool.

FIG. 26 is a screenshot of a user interface associated with the Complete aspect of the inventive SWAT tool.

### DETAILED DESCRIPTION OF THE INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

The present invention provides a Sales “Walk About” Tool (“SWAT”) that includes visualization functionality and a project profile and data capture routine(s) as part of a client-side application or online accessible user interface. The SWAT may be implemented using a mobile user-client device such as an iPad or other tablet, smart phone, PDA, laptop, or other such device, to provide an effective mobile sales tool. The SWAT tool includes routines for processing and managing leads and projects to sales calls through installation. The SWAT tool may be used to assign projects to sales employees, track open sales efforts, capture project data, track and schedule projects, and evaluate relative effectiveness of sales techniques and customer interest in products.

The SWAT tool may be implemented in association with a manufacturer system and also optionally with a dealer system and may include one or more of a dealer portal, a dealer/contractor portal, and a customer portal. In operation, after a dealer/contractor has been set up with the SWAT tool, a Dealer/Contractor Administrator may assign a project to a particular salesperson or team. In one typical scenario, a dealer/contractor receives leads through a variety of sources (telemarketing, direct mail; home show, etc.). The lead may or may not go through a pre-qualification process, e.g., if the lead does not meet certain criteria it may be rejected and discarded requiring no further action. Once a lead is accepted or qualified, the qualified lead is added to the manufacturer or dealer “lead” database or project database and is preferably accessible over the manufacturer system (in one alternative the qualified lead may be accessible through a dealer system). In either event, the manufacturer and dealer/contractor have access to the lead and project data for evaluation, tracking, and other purposes.

The SWAT tool may then be used to perform pre-work or pre-sales call tasks, which may include data entry via the SWAT application. For instance, project or home owner information may be input, including: address; contact names; phone numbers; email addresses; Zillow or otherwise obtained building information; surrounding building or other information, building code information or requirements; etc. Much information may be automatically or semi-automatically derived from publicly available or fee-based services, e.g., Zillow, driving directions (Mapquest), Google Earth data including photographs or images if available.

Once a lead is assigned to a salesperson (can be reassigned later) it becomes a project with a sales cycle status of “prospect” or other initial status on the assigned salesperson's remote device. In this manner, leads can be entered, tracked and managed via SWAT. Preferably, only those leads that have not been disqualified or are actual prospects (only qualified leads) are assigned to a salesperson and sent to the iPad (or other remote device) as a project. SWAT may be used to determine availability and set appointment Date/Time. For example, SWAT may use Google mail/calendar, Outlook or other available utilities. The administrator preferably has access to all of the sales representatives' calendars and contact files. This may help the administrator find an available salesperson or an open time on a particular salesperson's calendar for an appointment. In one embodiment, SWAT interfaces with native Google mail and iCal features including upload/download to the mobile device (iPad, tablet). It is important to note that the invention may be used in a variety of scenarios. For example, not all dealer/contractors will have an administrator position. The salesperson may be the person entering leads and projects.

The SWAT tool may be used to schedule sales appointments and, if successful, installation appointments after the sale. An administrator may set an appointment to schedule a meeting for a particular salesperson or the salesperson can enter or modify an appointment directly into the calendar feature on his/her remote device. This action would send an appointment (along with other pertinent information already entered into SWAT) to the salesperson for viewing and scheduling, for example, on their iPad's iCal utility. This method is preferred to entering the appointment directly into the salesperson's Gmail or other un-integrated account because the appointment would be sent with the pertinent information the salesperson would need (described in detail below). In one alternative, the administrator may modify/delete the appointment from Gmail. The dealer/contractor administrator could choose to send a calendar invite to the building owner. As an alternative, the administrator could add the appointment directly into the Gmail account. Further, pertinent information obtained via SWAT and/or associated databases may be incorporated into the appointment.

In one manner, the administrator keys in the lead information and adds the project to the SWAT or project database. If a salesperson has been assigned, then the project is sent to the salesperson's associated iPad and/or other mobile device. The salesperson may be uniquely associated with an identified device, i.e., by assigning the lead to a particular salesperson the system is in effect associating the lead with a particular uniquely addressed device “owned” or operated by the particular salesperson to whom the lead or project has been assigned. Next, SWAT is used to set an appointment. In one manner, the salesperson can set the appointment using iCal. However, if it is done via the SWAT Application, the relevant project information (e.g., names, contact information, address, map directions, etc.) may be sent along with the invitation to the salesperson. For example, an administrator notices an opening at 1:30 in the calendar associated with salesperson #1 that fits the building owner's schedule. The appointment is sent to salesperson #1 (and can optionally be sent to the owner). In addition, home owner contact information may be added to salesperson #1's project file to facilitate communication and coordination between salesperson #1 and the owner.

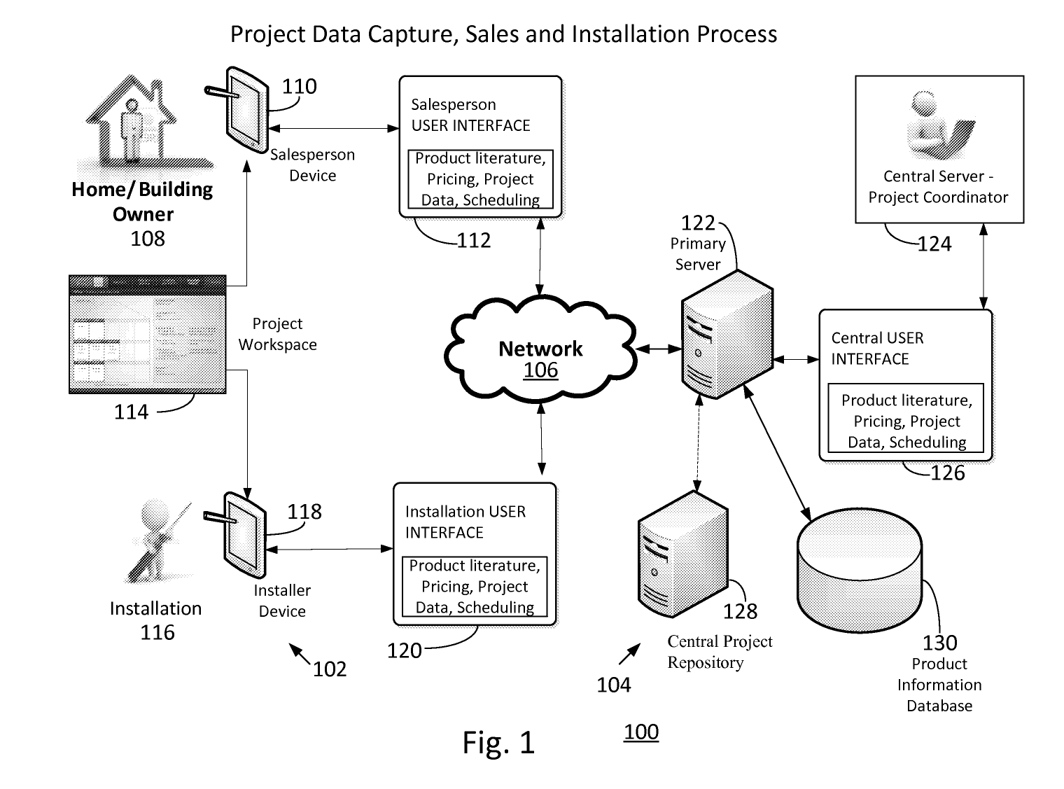

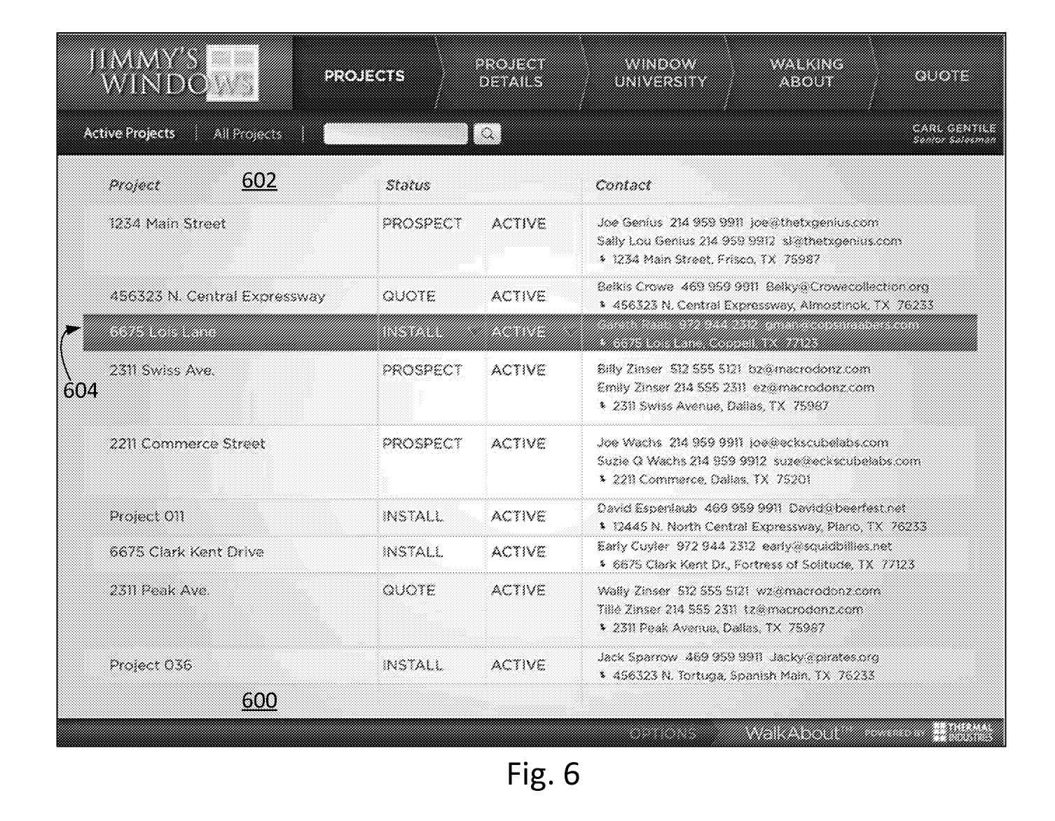

Referring now to FIG. 1, the claimed process may be carried out in conjunction with the combination of hardware and software and communications networking illustrated in the form of exemplary system 100. The system 100 is provided for the creating, associating, storing, reading and display of information related to product marketed and sold, such as in replacement building products (e.g., replacement windows, doors, siding, gutters, etc.). In this example, the SWAT tool is implemented across locally implemented functionality and devices 102 and one or more central server systems 104 connected from time to time via a network 106 such as the Internet. On the local or client side 102, a home or building owner 108 may have need for replacement products such as replacement windows. An inquiry may be made to a dealer or dealer/contractor or direct to a manufacturer and other lead generation processes may result in a sales call. A salesperson operating a remote mobile device 110, such as an iPad, tablet, or other computing device, receives the lead as a project (see FIGS. 6-8) and performs pre-work in advance of making the sales call with customer 108. Pre-work may also be performed, in whole or in part, by a central project coordinator 124. The SWAT tool includes data, sales functions and user interfaces 112 for operating by the salesperson on the client device 110. For example, during a sales call the salesperson demonstrates product materials, portfolios, education resources to the home owner using the device 110. Data and materials (including lead, project, product and pricing/discount data and content) may be downloaded to the device 110 over network 106 from primary server 122 of central server system 104. This may be as part of a dealer/manufacture representative business relationship.

A project workspace 114 user interface is generated and used during the call to collect data related to the project, such as existing type, condition and size of elements such as new windows or windows in need of repair or replacement. The salesperson uses the interface operating on the device 110 to survey the building and capture data necessary and useful in generating quotes and for follow-up purposes. After capturing the data the salesperson presents the information collected to the owner advising of condition and options, including replacement. The SWAT tool provides an effective tool for stepping the salesperson and the owner through the data and in making a quote based on the collected data in real-time at the time of the sales call. The SWAT tool includes functionality to present up-sell options and to compute further quotes based on revised product selections and options and to present same to the owner without having to leave the premises.

Quote and other project information generated during the sales call and otherwise may be stored locally on the device 110 and may be separately stored centrally at one or both of the dealer and manufacturer server systems. A central server project coordinator 124 by use of a central user interface associated with the SWAT tool may define assignments and restrictions related to leads and projects and to discount ranges authorized to salespersons. This may also involve permissions to market and sell a select set of manufacturer products. Information from product database 130 may be accessed by central server 122 for providing to the client device 110 and or to a dealer system. Scheduling aspects may be handled centrally and pushed down to the client device 110 as part of the coordination and assignment of projects and leads. After a successful sales call and resulting contract, the SWAT tool includes installation support features for an integrated sales/installation cycle to improve effectiveness and customer satisfaction.

The configuration thus described in this example is one of many and is not limiting as to the invention. Central system 104 may include a network of servers, computers and databases, such as over one or more LAN, WLAN, Ethernet, token ring, FDDI ring or other communications network infrastructures. Any of several suitable communication links are available, such as one or a combination of wireless, LAN, WLAN, ISDN, X.25, DSL, and ATM type networks, for example. Software to perform functions associated with system 104 may include self-contained applications within a desktop or server or network environment and may utilize local databases, such as SQL 2005 or above or SQL Express, IBM DB2 or other suitable database, to store documents, collections, and data associated with processing such information. In the exemplary embodiments the various databases may be a relational database. In the case of relational databases, various tables of data are created and data is inserted into, and/or selected from, these tables using SQL, or some other database-query language known in the art. In the case of a database using tables and SQL, a database application such as, for example, MySQL™, SQLServer™, Oracle 8I™, 10G™, or some other suitable database application may be used to manage the data. These tables may be organized into an RDS or Object Relational Data Schema (ORDS), as is known in the art.

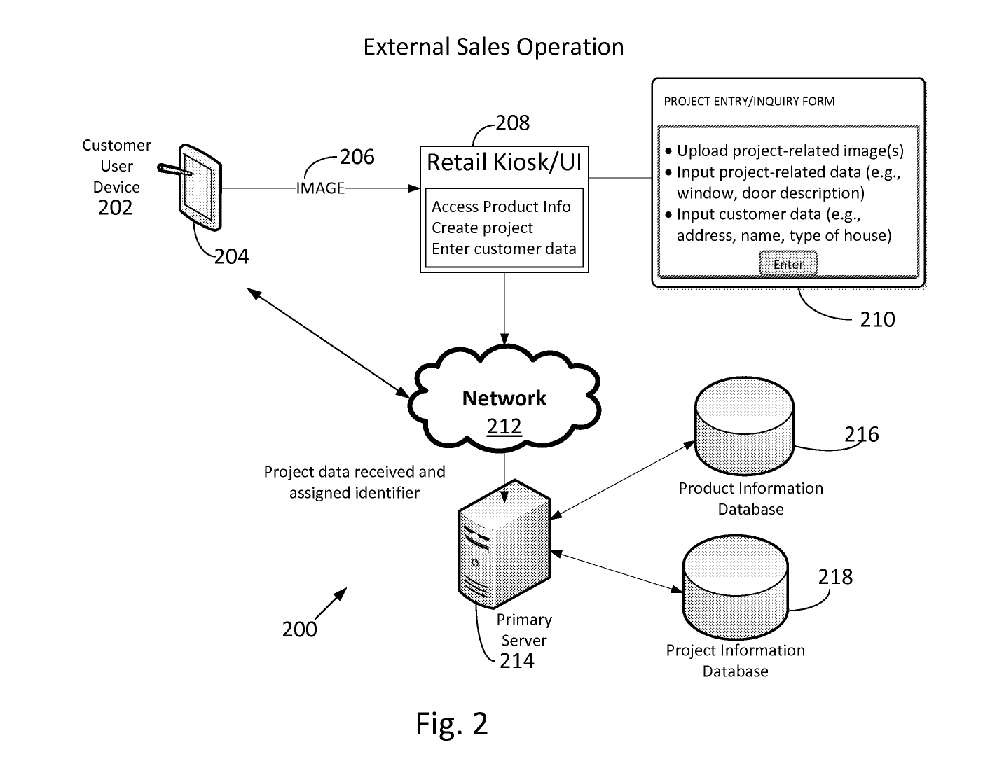

FIG. 2 represents an alternative embodiment of the present invention for use in retail/kiosk/Internet deployment. With reference to FIG. 2, a potential customer 202 using a mobile device 204 may upload an image 206 to a retail counter, Internet site or kiosk type station 208 having a user interface to facilitate lead generation and sales call events. A project entry or inquiry form 210 may be presented to a user to handle the transaction. A customer 202 may access product related information related to replacement products. The retail/kiosk/Internet user interface may be part of the SWAT tool and may include integration with the in-home sales tool so that it in effect functions as the initial front end of the SWAT walk about tool. The dealer or manufacturer may receive any uploaded images of a home and prepare the image to create a visualization to present to the home owner as part of a subsequent sales call. For example, a home owner may upload a photo of the exterior of the homeowner's house via a user interface of a retail kiosk or Internet site, which image then may be communicated over an Internet connection to a central server for rasterization and/or other visualization processing. The visualization may include representing a “before and after” image of the home or building with the before image being the original image and the after image showing a prospective view of how the home or building will look after replacement of the particular building elements (e.g., windows, doors, siding, gutters, etc.) with new products. The visualization may be delivered to the user by way of email or through a customer portal or other suitable access. The customer may request changes and/or be able to modify the visualization in advance of a sales call or independently of a sales call.

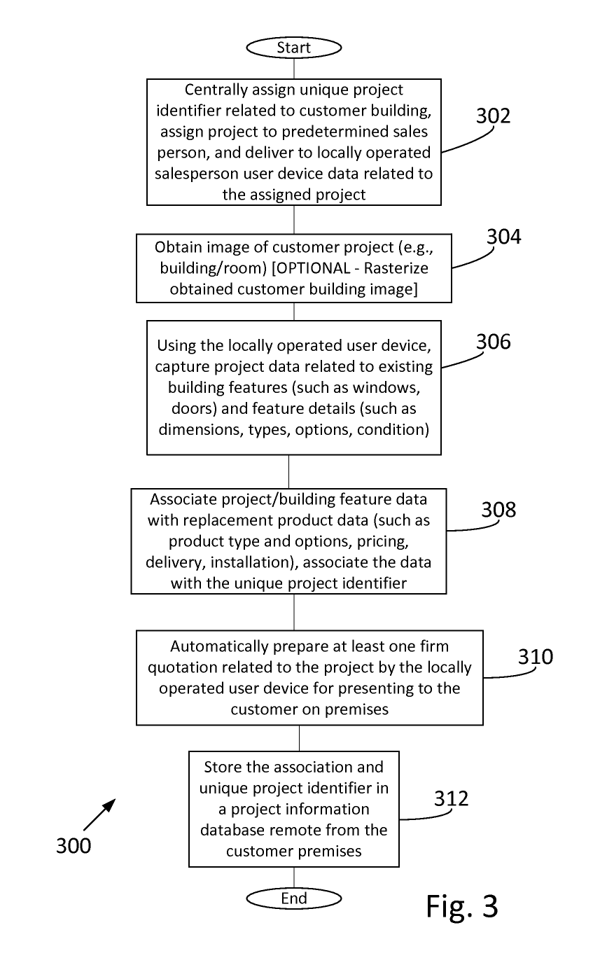

FIG. 3 illustrates a flow chart associated with steps in performing aspects of the present invention. As shown, process 300 begins at step 302 with centrally assigning unique project identifier related to a customer project, assigning a project to a predetermined salesperson, and delivering to locally operated salesperson user device data related to the assigned project. Not shown in FIG. 3 but discussed elsewhere herein is the process of beginning a sales call by presenting a customer with educational materials related to the project, including about the replacement building products, prior projects (portfolio), and information about the dealer/contractor and or manufacturer. At step 304, and typically following the in-home project education phase, a salesperson may “walk about” the project and obtain images of the customer project (e.g., building and/or room), such as by using a camera integrated with the mobile device operated by the salesperson and running the SWAT tool. Optionally, the system may rasterize obtained customer image(s)—this may be a separate process and outside the sales call and project walk about phase. At step 306, using the locally operated user device, the salesperson captures project data related to existing project features (such as windows, doors, siding, gutters, hardware, lighting, fixtures, etc.) and feature details (such as dimensions, types, options, condition). At step 308, associate project feature data with replacement product data (such as product type and options, pricing, delivery, installation), associate the data with the unique project identifier. In addition, and as discussed elsewhere herein, the salesperson may work in consultation with the customer to design the solution and various alternative scenarios, which may include further customer education and further visualization of the project. At step 310, automatically prepare at least one firm quotation related to the project by the locally operated user device for presenting to the customer on premises. Additional quotations related to alternative scenarios and project options may be generated and presented during this same sales call using the SWAT tool. At step 312, the SWAT tool stores the association and unique project identifier locally and, such as by connection at some point in time with a central server over the Internet, store project data in a project information database remote from the customer premises.

Not shown in FIG. 3 but discussed elsewhere herein, the salesperson may also use the SWAT tool to present for review and execution by the customer a contract related to the project and concerning delivering and installing building products. By providing the salesperson the ability to “close the deal” during this initial sales call and in the customer's home/building, the SWAT tool greatly enhances the likelihood of success associated with the sales call. Further, by uploading all of the project data to the central project database, the SWAT tool facilitates the follow-up sales process in the event of an unsuccessful initial sales call. Often and in some industries referred to as “rehash,” the manufacturer and/or dealer plans and schedules a follow-up contact with the customer to determine, among other things, whether the customer carried out the project with another manufacturer/dealer, why the customer elected not to enter into a contract to complete the project, whether the customer is interested in discussing again the possibility of having the project completed or other options or products or scope of the project, and additional information helpful in future efforts. Often a “rehash” specialist may be used and the SWAT tool may be used to reassign the project to a different salesperson for the follow-up effort.

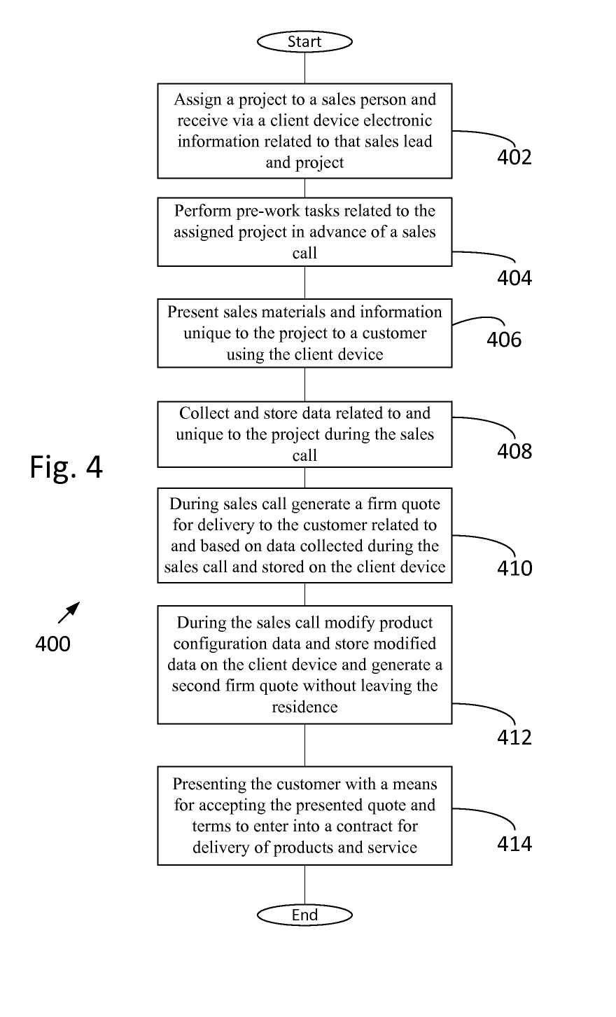

With reference now to FIG. 4, a process 400 is described for preparing for and making a sales call using the SWAT tool of the present invention. At step 402 a salesperson is assigned a project and receives via a client device electronic information related to that sales lead and project. At step 404 the user performs pre-work tasks related to the assigned project in advance of a sales call. At step 406 the user presents sales materials and information unique to the project to a customer using the client device. At step 408 the user collects and stores data related to and unique to the project during the sales call. At step 410, during the sales call the user generates at least one firm quote for delivery to the customer related to and based on data collected during the sales call and stored on the client device. At step 412, during the sales call the user modifies product configuration data and stores the modified data on the client device and generates at least one second firm quote for deliver to the customer without leaving the residence. At step 414, the user presenting the customer with a means for accepting the presented quote and terms to enter into a contract for delivery of products and services.

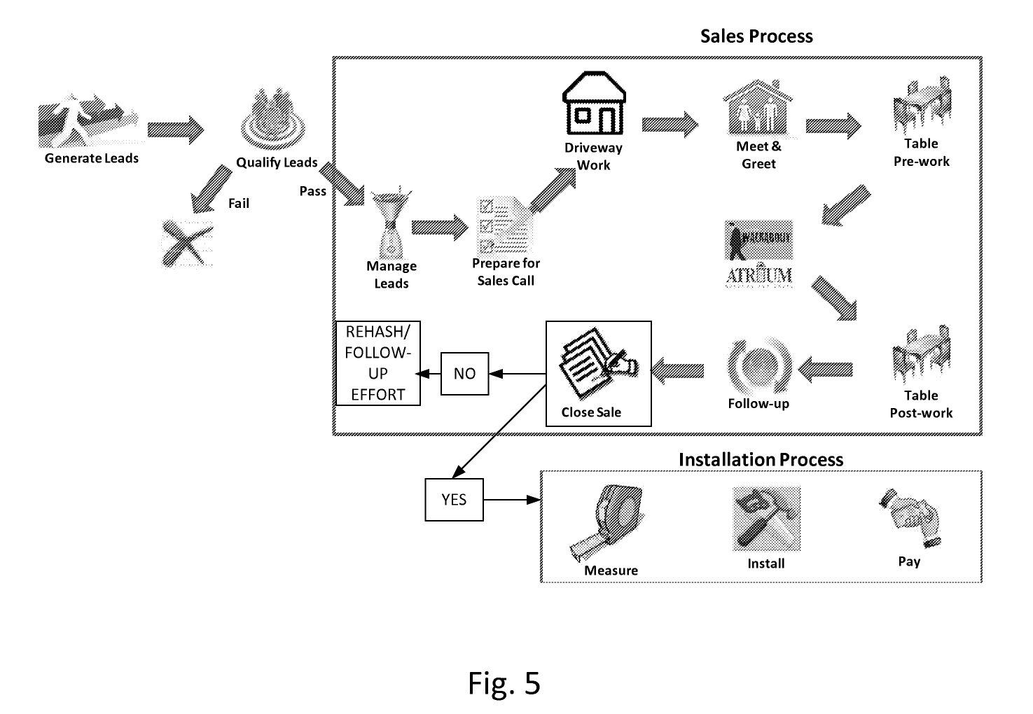

With reference now to FIG. 5, a detailed system diagram is provided to illustrate the flow of data for the lead generation and screening process, the sales process and the installation process. These processes may be carried out in conjunction with the combination of hardware and software and communications networking illustrated in the form of exemplary systems of FIGS. 1 and 2 and flows of FIGS. 3 and 4.

FIGS. 6 through 8 depict a series of screenshots from an exemplary embodiment of a user interface for managing projects. The SWAT tool includes user interfaces for data entry and to “Add/Update Projects” and “Set Appointments,” e.g., a Set Appointment Form. Much of the data presented by an iCal appointment details window may be automatically derived from contacts and other data files stored in existing records available to SWAT. For example: a project may be assigned a name or default from the address; homeowner may be copied on calendar invite; default to a 30-minute alert; and Web address links included to maps page with driving directions. In one manner meeting details on iCal may be as follows. The appointment has been sent to salesperson (SP) #1's calendar for a 1:30 PM appointment. SP#1 receives the standard iCal notification of a proposed appointment once delivered to SP#1's account. SP#1 may accept or decline the invitation. Note that the salesperson can use the iCal directly to enter personal appointments. It's important that the dealer/contractor administrator see these appointments, e.g., through Google. Although “Contacts and Appointments” functions may be handled separately from SWAT, SWAT could include a dedicated contacts and appointments function.

SWAT includes a web-based or client-side application operating on a local salesperson mobile device (“SD”). A salesperson user interface (“UI”) utility presents data input and management screens for use by salespersons before, during and after sales calls. New and existing projects will appear on a salesperson's screen or personalized homepage and may be “pushed” from a manufacturer's system and marked, e.g., “new.” Preferably, the SWAT tool centrally adds or pushes projects directly to the salesperson's mobile device (e.g., iPad). In one alternative, a dealer system may also be involved to varying degrees in this process. In any event, once a list of projects assigned to or otherwise associated with a salesperson is displayed on the salesperson's mobile device (“SD”), then the user salesperson may “touch” or click on a button or link to bring up a screen related to a selected project. This will allow the salesperson to present screens concerning project details (e.g., Project Detail; Window University; WalkAbout™ Mode; Quoting/pricing). Projects may be moved or reassigned to other salespersons (or deleted from any salesperson's account) using the SWAT Administration module at the central server-side, e.g., by a dealer/contractor administrator operating the administrative function and user interface of the SWAT tool provided by the manufacturer.

Preferably, on a given screen only active projects are displayed by default (there will be a table of valid statuses and whether the status is active or inactive). This table will be defaulted by SWAT. The dealer/contractor will be able to modify the values to fit business model and needs. This data may be stored separately at the dealer and manufacturer system/sites respectively, and may be maintained elsewhere for backup and redundancy or for partner use. Preferably, unsuccessful or stale projects are removed or separated from live projects. Completed projects may be included in the portfolio or be removed. The necessity at the local level may be driven by storage limitations on the user mobile device (e.g., iPad or tablet). The system may allow the salesperson latitude in the ability to archive or inactivate a project. Once archived or inactivated, for example, only the project name, status and contacts remain on the iPad. The project details will remain in the central server-side portion of SWAT indefinitely or for a predetermined time period.

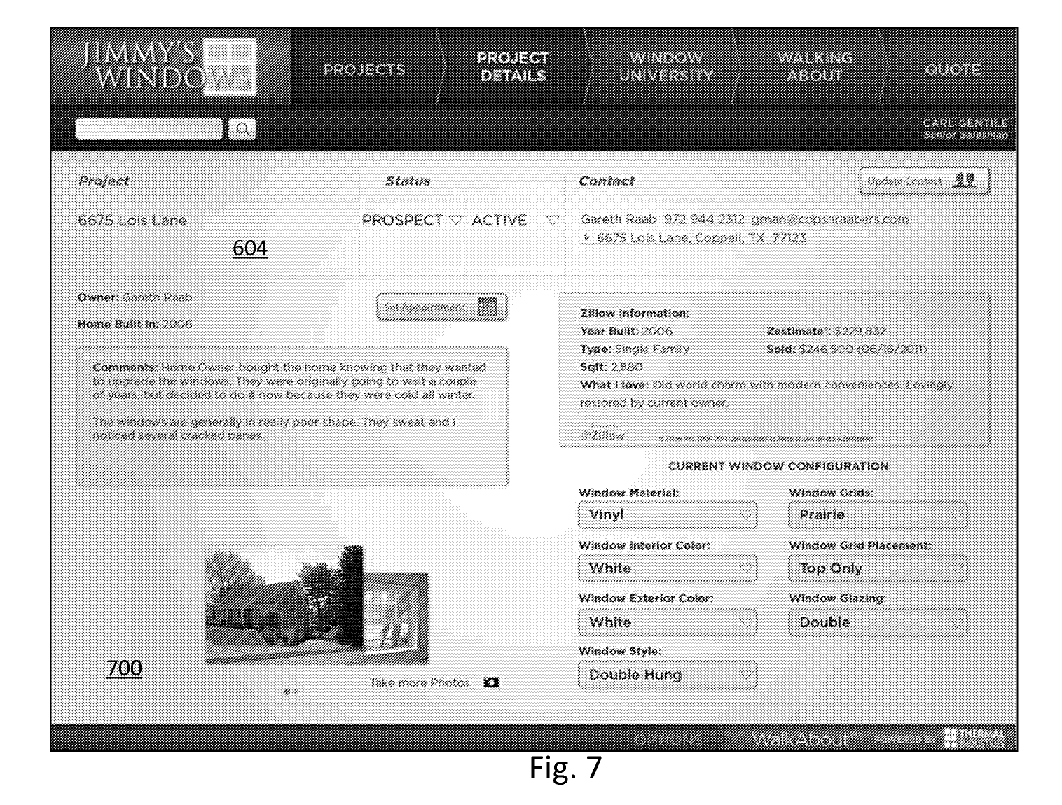

FIG. 6 is an example “PROJECTS” screenshot 600 that shows user interface aspects of the SWAT tool from the perspective of a dealer/contractor salesperson view when using the present invention. As shown in screen 600, the user salesperson is presented with a list 602 of nine active projects displayed for selection. The Lois Lane project 604 is shown highlighted as being selected for access by the user. Upon selection, the user is directed to the screen 700 of FIG. 7.

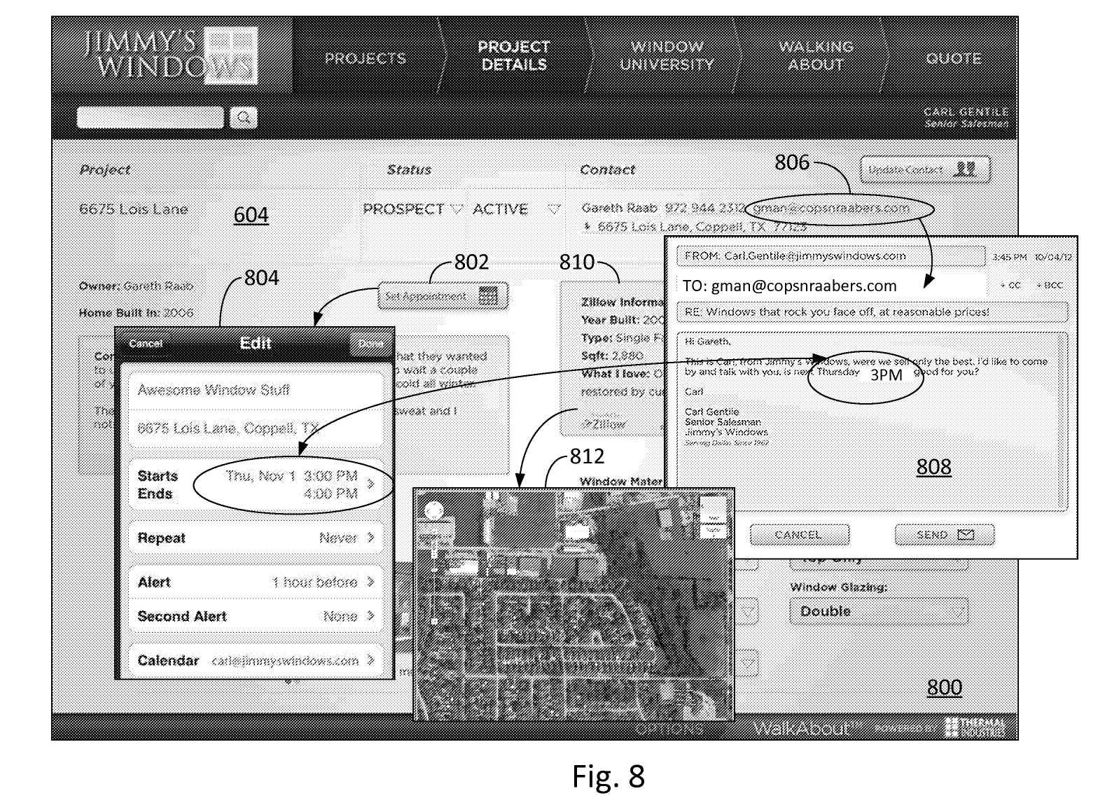

With reference now to FIG. 7, a screenshot 700 represents an exemplary input screen for a dealer/contractor salesperson managing the Lois Lane project 604 of FIG. 6. Details and information concerning project 604 are provided for access and action by the user. Data may include contact data, home data, and information obtained or links to third party resources such as Zillow. If known, information related to existing building features, e.g., window material, color, style, grid pattern, etc., may be displayed. This information may be used by the user in performing pre-work preparation. In one manner, when a salesperson touches or clicks on a contact name or contact email address, the system automatically prepares an email. Touching the address should display a map with driving directions. A “Project Detail” (or pre-work) screen (FIG. 8) presents a user interface and view that the salesperson uses to prepare for the sales call. Much of the information included on this screen is downloaded from the SWAT or associated database. This download will happen in much the same way as email and calendar downloads work (when connection is available). Most fields on this screen are updateable and backwards synchronized with the SWAT. In one manner of operation, data is associated at the project level so the contacts and all other project related information will be associated with only projects (i.e., there is no need to have functionality to manage contacts separately). A “Search Project Detail” utility may be provided to enable a user to search for information related to the project detail (contact, address, description, etc.) for all projects and return matching results.

With reference now to FIG. 8, screenshot 800 illustrates functionality called upon by a salesperson operating the user interface described hereinabove. For example, if the user selects “Set Appointment” button 802, then an iCal event or calendar record will appear for editing and saving, e.g., setting a 3 pm appointment with a customer on Thursday, November 1. Upon selecting a contact email 806, for instance, an email form 808 may be generated with certain if not all fields automatically populated. This may be done in connection with iCal or other calendar functionality as well. In addition, selecting the contact address may prompt a map to appear and selecting a feature, such as on Zillow, may cause a Google Earth or the like image to appear for reference by the user.

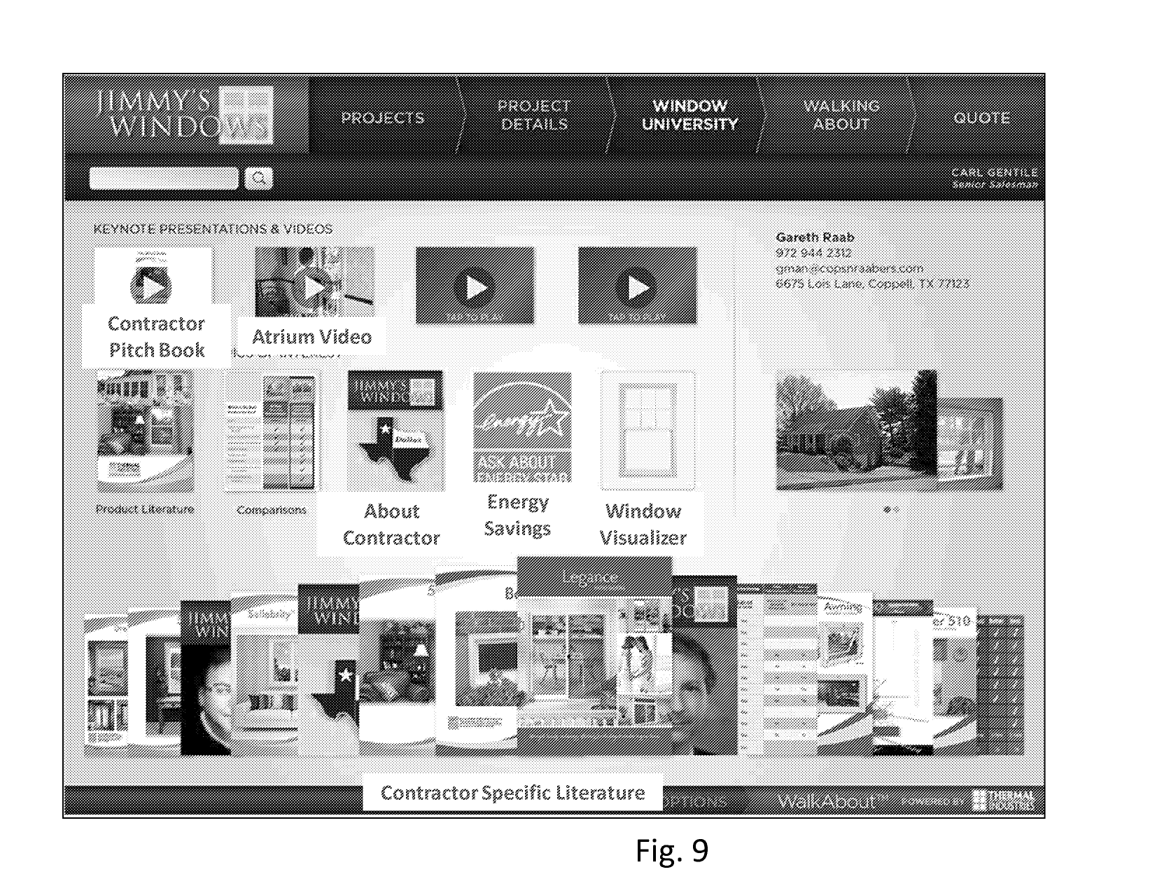

FIG. 9 depicts an example of a sales tool area designed to assist the salesperson in presenting information and options related to the product, e.g., replacement windows, doors, etc., and/or service. In this exemplar, the page includes education resources. This area may be dealer/contractor branded and tools to enable the dealer/contractor to incorporate branding, personalized content, and images may be provided for dealer customization even if the core code and content are maintained by servers associated with the manufacturer. Also, the window brands available may depend on the relationship between the manufacturer and the dealer/contractor. Logos and other indicia may be used to signify that a dealer has attained a certain level of proficiency or quality as determined by the manufacturer and may indicate the availability of the visualization tool. The system may allow further dealer/contractor customization to tailor the sales presentation (such as dealer/contractor materials). The SWAT system allows for import of pictures from photos and interaction with other applications. Some pictures may be obtained and associated with a given project, some of which may be associated with a given room as part of the project.

The “Window University” area helps a dealer/contractor and salesperson “tell their story” to a customer. The SWAT may include tools to enable the dealer to name and format this sales section and may include one or more of: 1) a PDF or book style document set; 2) Bio or background about the salesperson, dealer and manufacturer; and 3) access to a website or portal related to the product and service (provided connection available). The SWAT sales tool is preferably configured so that the salesperson has access to tools and content at the local remote level using the mobile device without relying on a network connection. Synchronization and/or some functionality and content may be available only by way of network connection. Preferably, documents related to the sales call can be emailed to any contact during a presentation, e.g., email to the end user customer with attached quote and/or product materials for subsequent reference or upon execution of contract.

Manufacturer preferably has a content management area or interface with the SWAT tool to define the set of products, e.g., window series, the dealer/contractor is authorized to market and sell. A series of materials related to the available products (window series) is provided to the dealer and sales personnel. The dealer/contractor can further limit the series by salesperson. The goal is to interface the product materials and allow an administrator some degree of control on where it shows up on the SWAT sales device and presentation—the look and feel. A search function is provided to help identify content of interest. Some dealers/contractors use their own nomenclature or “private label” for represented products. So the product naming for the widow literature links has to match what is in the brochure and is preferably customizable.

Preferably “baseline” configurations are arrived at or defined during the initial sales call and walk about phase during a “solution design” phase of the sales call. Solution design involves, as discussed herein above, project visualization and consultation of the homeowner during the sales call. Alternatively, a baseline configuration may be arrived at pre-sales call during the pre-work phase, e.g., after some initial upload of project information (images) via the retail sales kiosk or Internet site of FIG. 2. In any event, the SWAT tool includes a “baseline” interface and may use functionality provided by an existing visualization solution, e.g., RenoWorks. This interface provides a side-by-side configuration tool that allows the user to make changes on a “floating” image or product representation (e.g., a floating window is one not associated with or physically tied to a wall but simply “floating” on the screen). The user may make selections from a list of features related to a product, e.g., replacement window, with selections reflected in a visual manner on an associated image of the window. In addition product literature related to the selectable or available options may be accessible by the user for review and presentation, such as during a sales presentation for up-selling a customer. The “baseline” window becomes the default selection during the WalkAbout sales call portion of the program (discussed below). Selections may be limited to those that are common and available (e.g., no tempered; no obscure). In this example and with respect to glass selection related to a replacement window product, two exemplary methods of configuring the glass package follow. The user would set the method as a default (glass packages) and can toggle between the two methods during configuration. A first method for setting glass packages are based on marketing names (e.g., Clear, Energy Efficient, Energy Star). The second method allows identification based on individual glass components. Also, features such as “grid patterns” (e.g., divided light, six-pane, etc.) may be shown and adjustable. For example there are grid standards based upon window size.

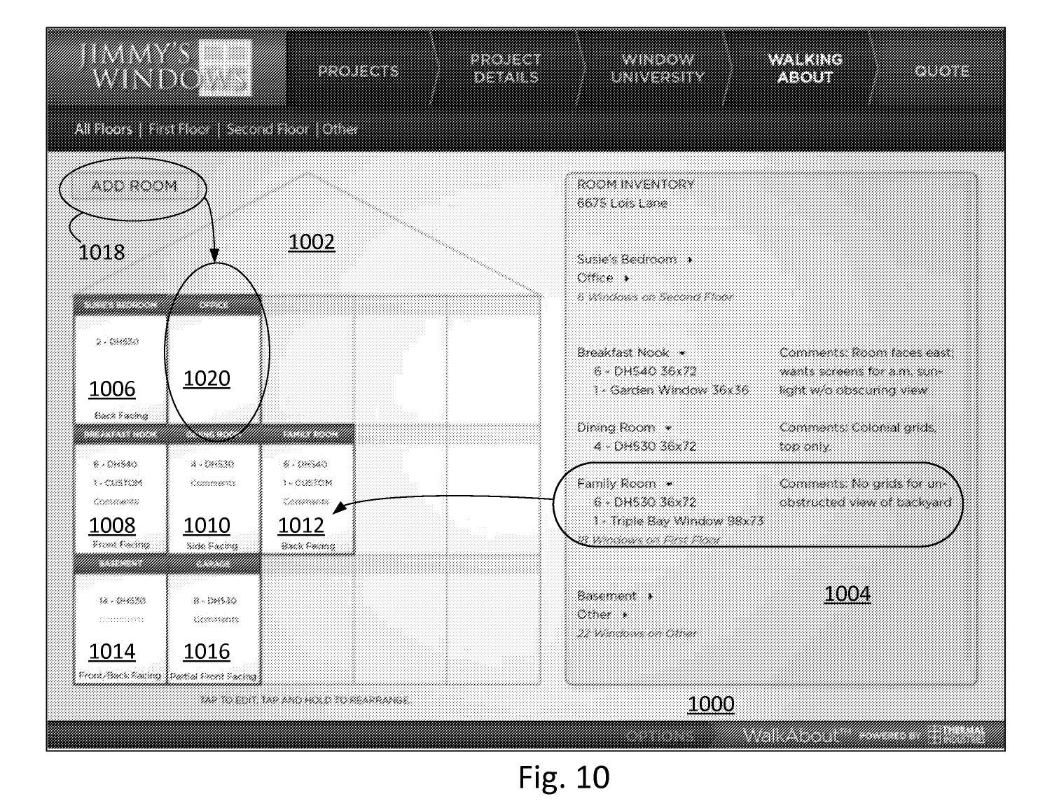

FIGS. 10-17 illustrate the project data collection or capture process of the client-side application of the SWAT tool. Although the figures, including FIGS. 10-17, and the invention may be discussed in terms of “windows,” it should be understood that these descriptions are merely exemplary and the invention is not limited to this type of product or element or application and in fact may be used in connection with a wide variety of building products and applications. The SWAT tool provides the salesperson with a means for surveying or “walking about” the house and imaging, measuring, selecting, configuring, designing, and eventually generating and presenting firm quotes related to the project. It is important to note that by loading product pricing and discount and other data onto the SWAT tool operating on the mobile device the salesperson is able to offer “firm” quotes to the customer during the sales call. In the past salespersons were not always able to offer “firm” quotes and had to return to a sales office to calculate firm offers for acceptance by a customer. Accordingly, the SWAT tool enables a salesperson to close a deal on premises and at the time of the sales call thus increasing success rates.

The SWAT tool enables the salesperson to collect project data and customize project configurations, e.g., combination windows. Initially or upon surveying each room of a building, the user may create a layout of the building for assigning building features identified during the survey. Building features, such as windows, doors and other replaceable products, are identified and their locations (e.g., basement, first floor, second floor, third floor, exterior, etc.) are captured. The data collection process is implemented by way of user interface screens. For instance, floor layouts or mock ups may be pre-canned or generated and the user may assign window locations in rooms and on walls and/or exposure. In this manner the project is customized and personalized (e.g., Timmy's bedroom) to match the building being surveyed and the interface is highly visual.

In one manner, the system may include a predefined or “seeded” list of default or common room type names (e.g., office, kitchen, bedroom, basement) and the salesperson can add custom names (e.g., Timmy's room). After initial capture, when the project proceeds to order, manufacture (if custom), and installation, the assigned room names (and any other comments) may be carried through the SWAT systems and processes and end up as a sticker on the window. For instance, the particular windows to be installed in Timmy's bedroom may be marked “Timmy's bedroom” and may also be marked with respect to the facing (e.g., side, front, back) to assist the crew installing the windows.

For instance, as the salesperson adds a window he will face the wall where the window goes and he may take a photo of the wall for reference and for rasterization and visualization discussed in detail elsewhere. The data capture system may include a compass function or make use of existing functionality on an iPad or tablet or other device. The compass setting may be stamped or associated with the window location and replacement placement. Location and exposure data may be used to generate energy calculations and window grouping at quoting time, e.g., “Just quote all front or south facing windows as Phase I.”

With reference to FIGS. 10-17, as the salesperson “walks about” and surveys the home he builds out a virtual representation of the home including rooms and room layout and makes note of existing windows in the home to define the scope of the project. The cost of the project is based on several factors (number of windows, window type, size. options selected, mulling/joining, standard installation, contracting work and tax). The salesperson's measurements are generally taken in the form of united inches (i.e., horizontal measurement added to vertical measurement). For purposes of quoting, a rough or approximate measurement will suffice (e.g., for windows 0-110 united inches is price 1 per type, 111-150 united inches is price 2 per type, etc.; and for doors vertical height may be the measure used for determining pricing). However, approximate measurements taken during the sales call and data capture process are not accurate enough for purposes of measuring, manufacturing and installing. Accordingly, the SWAT may also include an installation module capable of accurately and efficiently capturing reliable and highly accurate measurement data or highly accurate data collected at any stage may be referenced or marked as such. For instance, during the initial sales call and data capture a reference device (such as a ruled or graduated reliable measurement reference) may be placed proximate to the existing window. Upon taking an image of the existing window with the reference an automated process may be used to accurately determine the actual dimensions of the existing windows and therefore the dimensions of the replacement products, e.g., windows, doors, etc.

With reference to FIG. 10, the SWAT tool provides the user with an interface screen 1000 that includes, in this example, a graphical representation of a building or home 1002 and a “Room Inventory” 1004 section that lists in detail the existing building elements, such as windows or doors, identified in the building for possible replacement. The user uses “Add Room” button 1018 to add rooms as he surveys the building walking from room to room or at least those areas of concern. Graphical representation 1002 may include floor-by-floor representations of the rooms surveyed. In this example, the user has added Susie's Bedroom 1006 to the second floor, Breakfast Nook 1008, Dining Room 1010 and Family Room 1012 to the first floor, and Basement 1014 and Garage 1016 to the basement floor of home 1002. As windows are added on a room-by-room basis, list 1004 automatically reflects additions and changes to the listing for each room. The user may add Office to the home 1002 by tapping button 1018 and selecting a name or identifier for the new room.

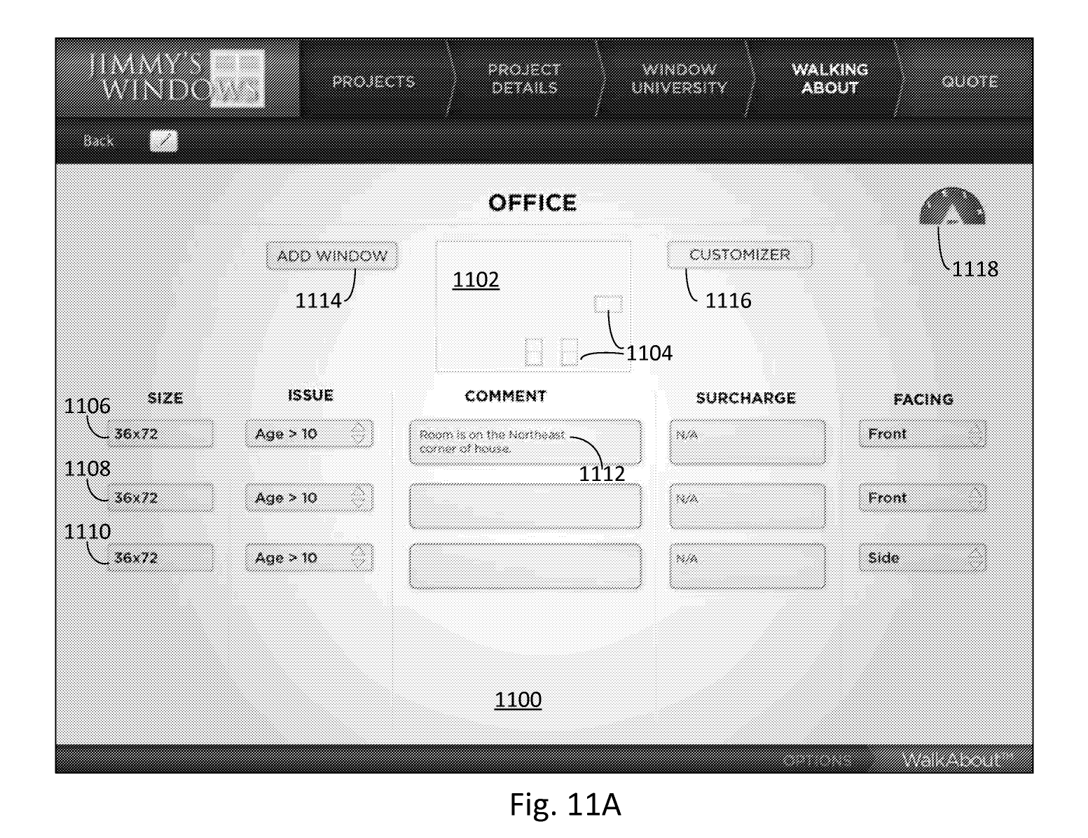

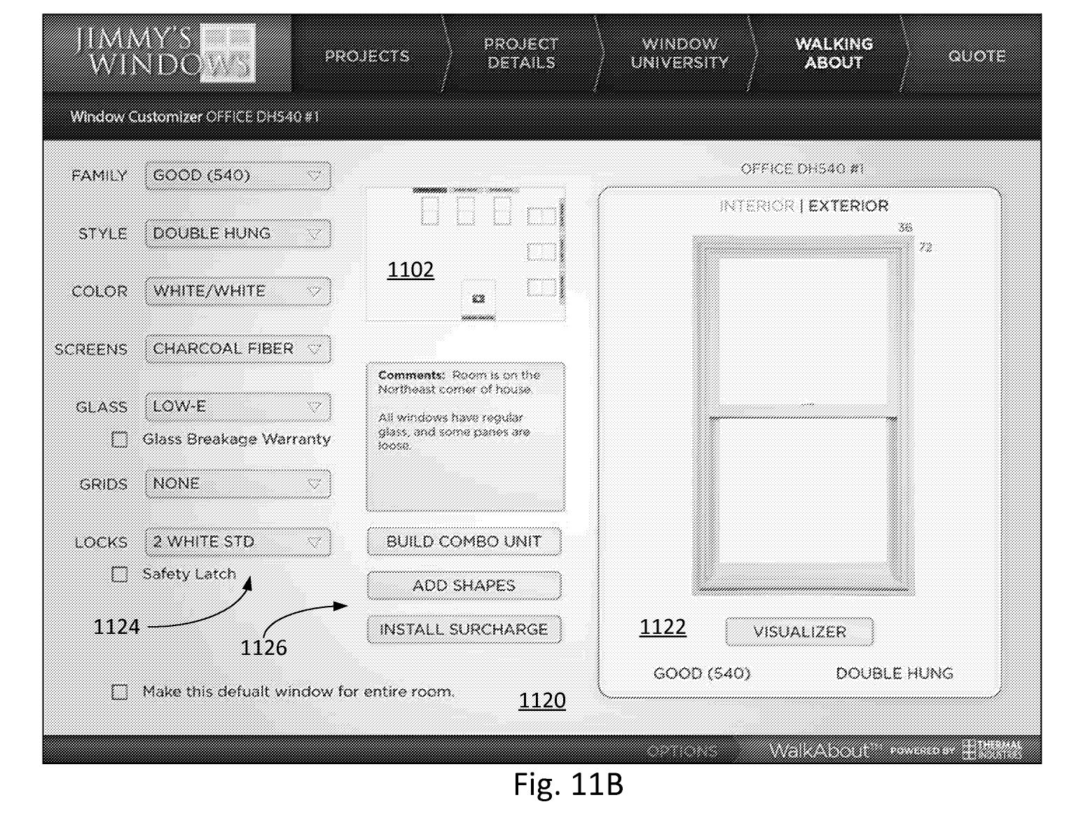

With reference to FIG. 11A, the user has added three windows 1106-1110 to the Office room. From this screen the user taps on “Add Window” button 1114 to add windows during the survey walk about data collection process. A graphical representation 1102 of the Office is shown with icons 1104 representing the windows listed below and showing the locations of the windows within the room. A customizer button 1116 allows the user to customize the data collection process. The user may add comments, e.g. comment 1112, to capture information relevant to the survey. Also, depending on the condition of the existing structure the user may need to capture situations that require special or extra needs to complete the installation, e.g., if existing surrounding building structure must be repaired before window can be replaced then the user can input a surcharge element to the survey which may subsequently be reflected in a quote to the customer and notes to the installer. This screen also provides a pull down list of “Issues” from which the user may select, e.g., the age or condition of the products, e.g., windows.

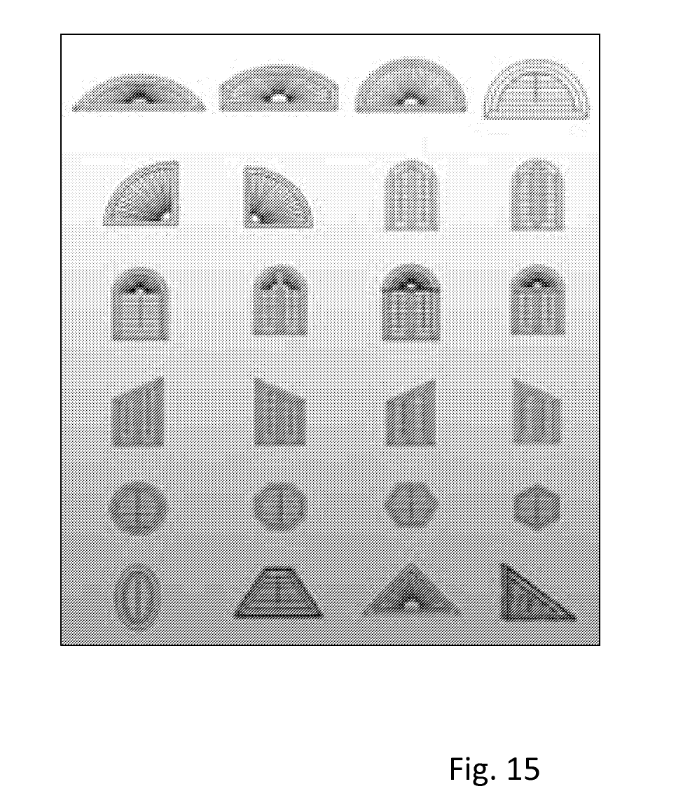

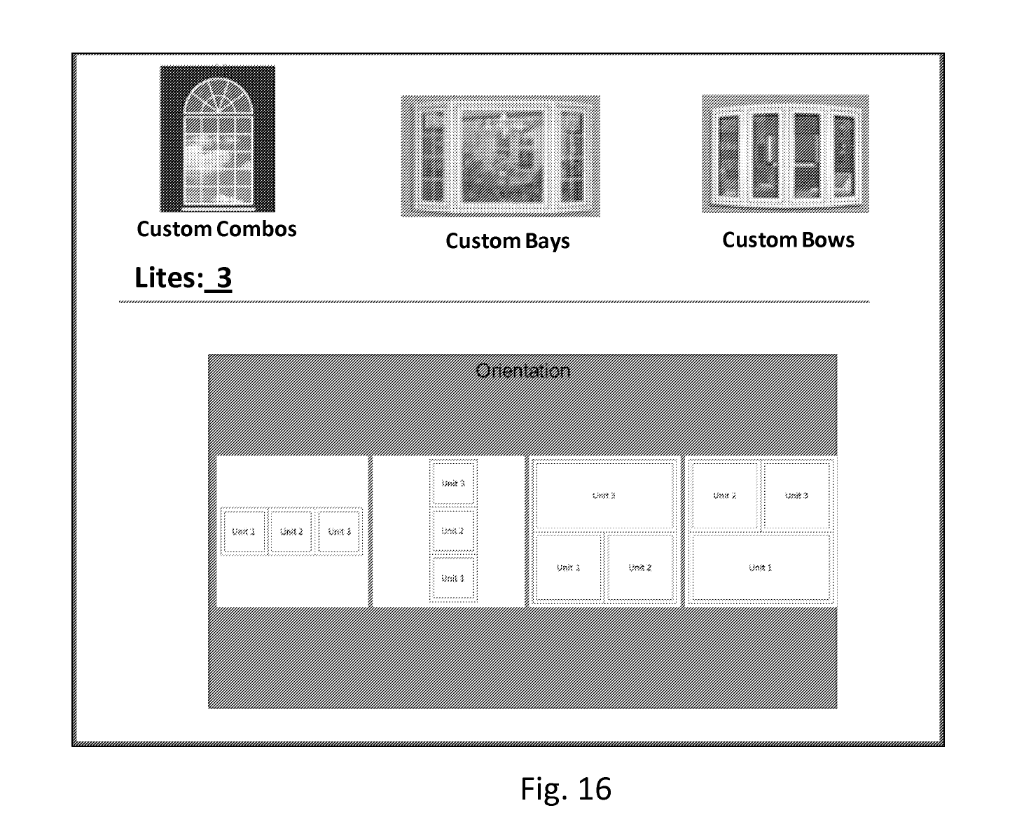

FIG. 11B illustrates a window “customizer” entry screen 1120 presented when a user taps the customizer button 1116. The screen 1120 includes the graphical representation of the room 1102 and an image or visualizer section 1122. Using this screen the user may select from a list of details 1124 and a list of upgrades 1126 related to the replacement window and to be reflected in a subsequently generated quote. For example, the user may select from pull-downs associated with the following exemplary window features: Family, Style, Color, Screens, Glass, Grids, and Locks. The user may then customize the window being entered by showing it as a “combo unit”, such as shown in FIGS. 16, 19 and 20, or having special “shapes” (see FIG. 15). The user may enter surcharges related to the installation from this screen as well.

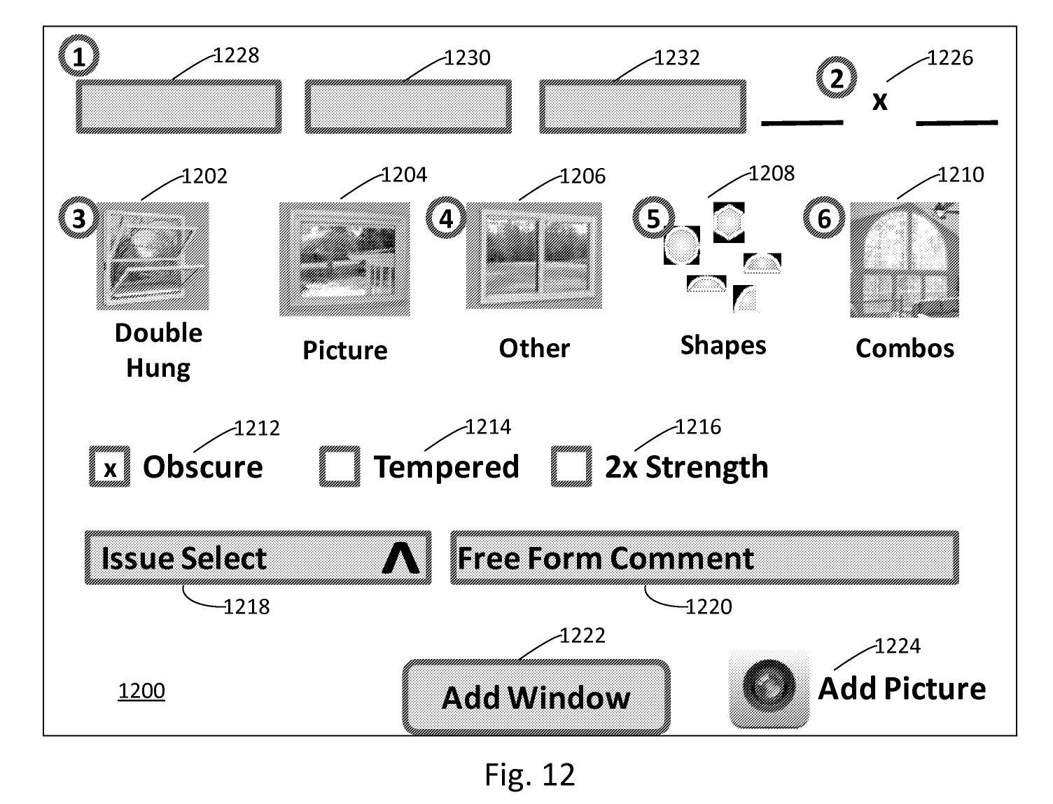

With reference to FIG. 12, the SWAT tool provides a “Detailed Window Entry” interface or screen 1200 to enable users to capture current product inventory, required measurements and other pertinent data. As shown in the user interface 1200, the SWAT tool provides a user entry interface that includes product type selections, in this exemplary screen related to windows—Double Hung 1202, Picture 1204, Other 1206, Shapes 1208, and Combos 1210. The screen also allows users to select glass types Obscure 1212, Tempered 1214, and 2× Strength 1216. In addition, a user may enter issues identified during a survey, which may be presented in the form of a pull-down menu 1218, and may enter “Free Form” comments 1220. The user may “Add Picture” 1224 from this screen and may “Add Window” 1222 based on user selection.

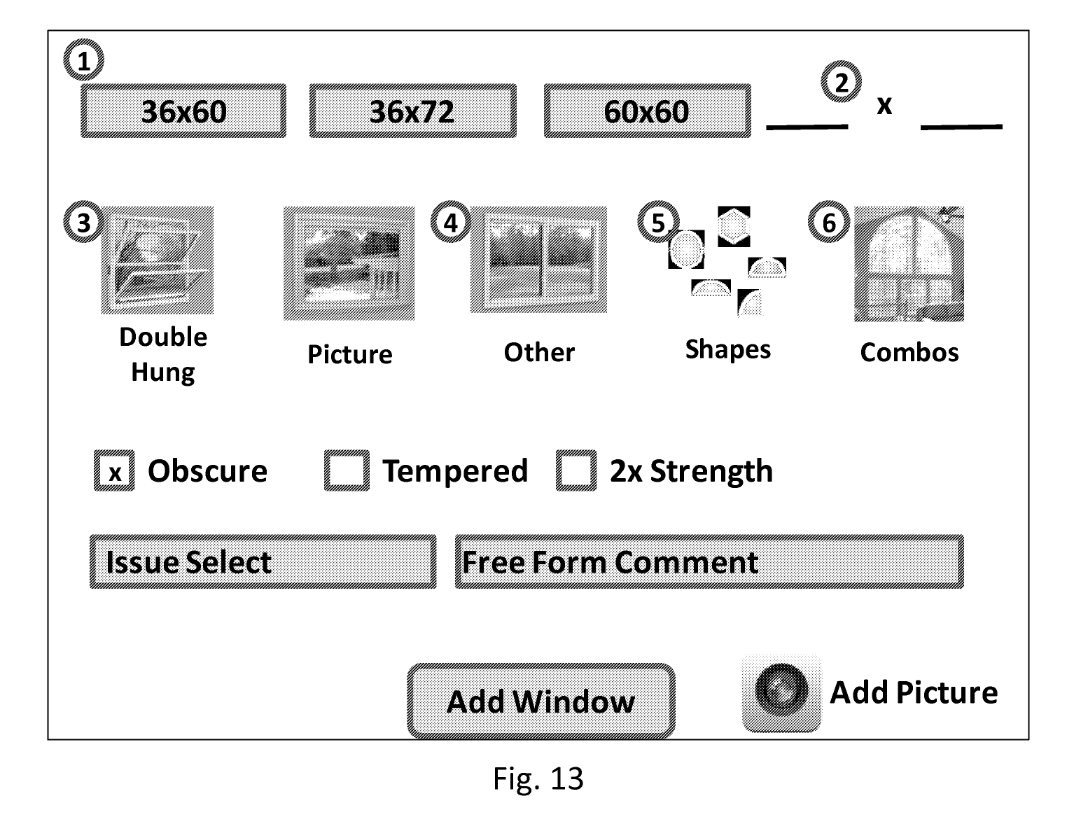

The Detailed Window Entry Screen includes an entry field 1226 for defining window size. As the salesperson enters window sizes observed in a home, the most common sizes for the home automatically appear in the shaded sections 1228-1232, i.e., the shaded boxes fill in the default spots for ease in subsequent window size entry. For the first entry of a new project, the salesperson uses the free form text entry field 1226 to enter the window size. In the alternative, the tool may come with the most common window sizes pre-defaulted on the interface. Once the first window is entered, that size would then default into the first shaded default box 1228 (and then become the default) and so on. FIG. 13 illustrates a situation where at least three window sizes have been entered, 36×30, 36×72, and 60×60. If the user desires to enter a size that is not among those defaults the user uses entry field 1226 to enter that new or other size.

The window type 1202-1204 will default based on the selection on the project detail screen. Once a window type is selected, the next default will be the window type that has been selected most often for this house. The “picture” window will always be in position #2 and “other” in position #3 (to get to non-standard windows). The “other” button 1206 brings up a list of possible windows from which the user may select. The “shapes” button 1208 brings up a list of possible shapes, which may or may not be dependent upon the window type selected, from which the user may select. The “combo” button 1210 allows the salesperson to easily configure a window (bow, bay or combination windows).

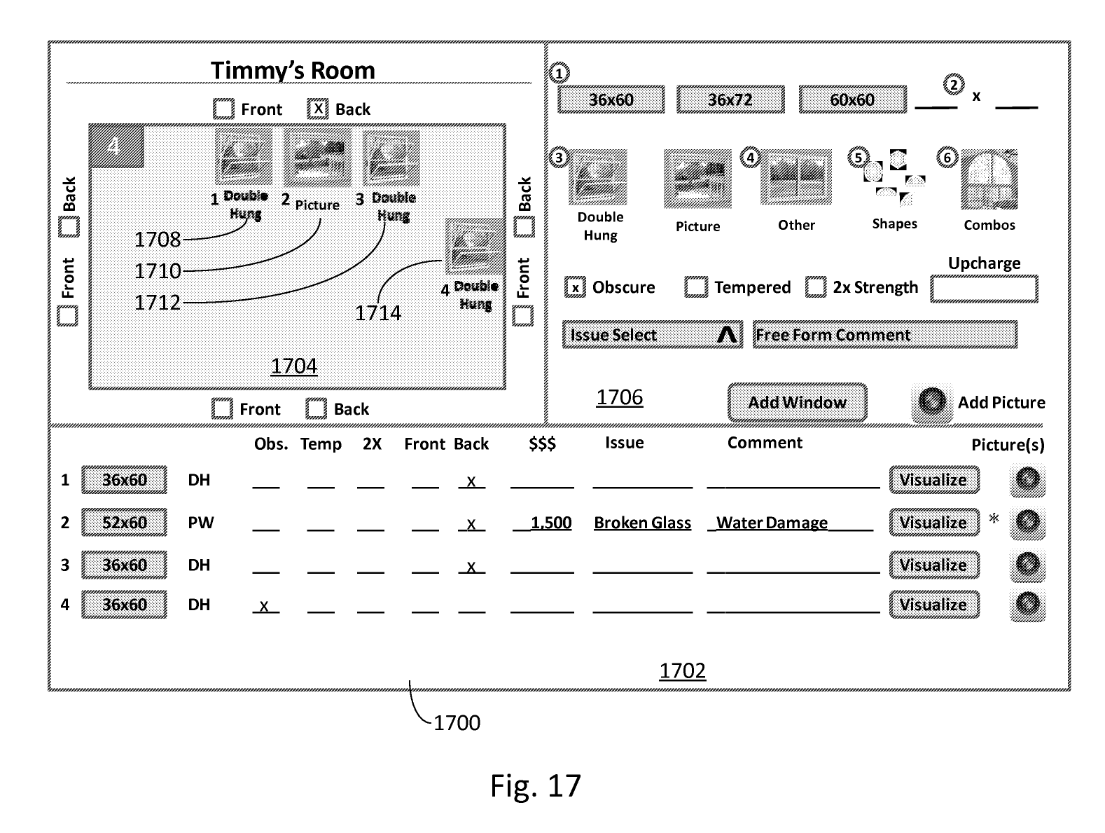

For example, with a project or “house” screen underway or built out, such as FIG. 10, a user may “tap” on a built room, e.g., Office 1020 of house 1002, and be able to see the detailed screen already filled out and to further add or modify the window settings for that room. Also, tapping on “Add Room” button 1018 allows a user to add a new room, as described above, and go to the detailed add screen such as FIG. 12. A seeded list drop down may be provided to enable the user to name the room based on a predefined list or the user may enter a custom name, e.g., not select a seeded name but key in “Timmy's room.” Using the detailed window entry illustrated in FIG. 13 and as resulting in the room configuration illustrated in “Timmy's Room” 1704 of FIG. 17, the user adds the four windows depicted in the room layout 1704 and in the list 1702. As shown in FIG. 13 and in the window detailed entry portion 1706 of FIG. 17, the most common defaults for window adds are “Double Hung” type and “36×60” size.

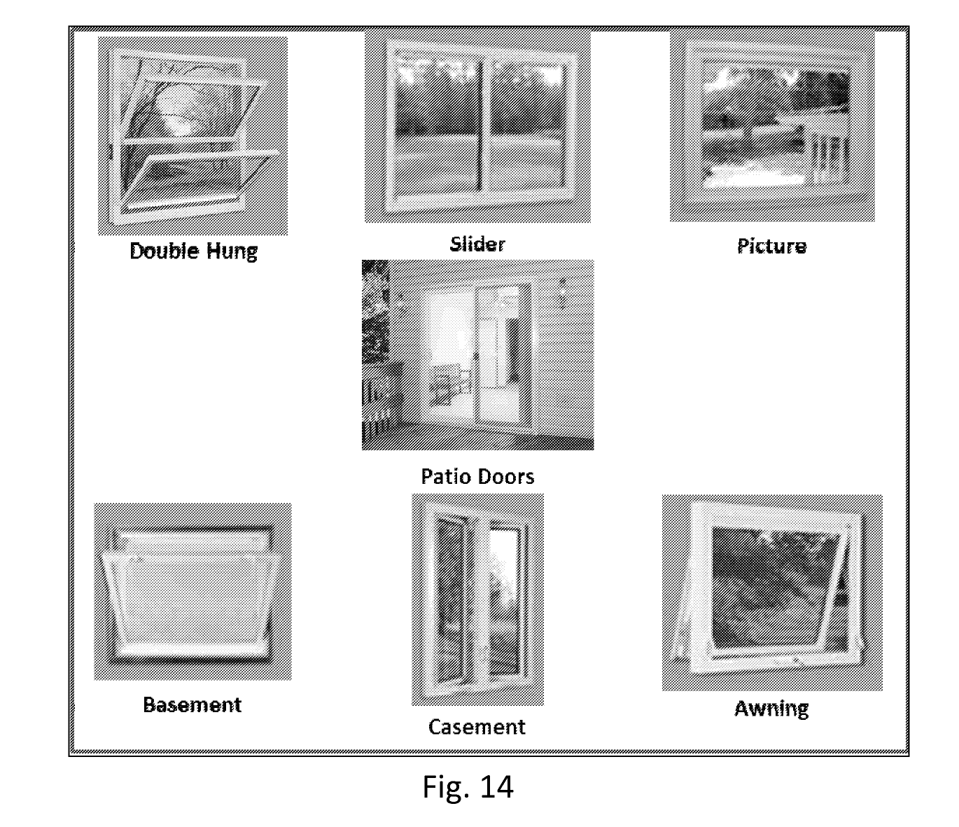

The user may tap the “other” button 1206 to reveal other types of windows such as by a pop-up window (FIG. 14) or list. In this example there is no need to add any intelligence, just the pop-up screen selection. The user may tap the “shapes” button 1208 to reveal shapes such as in a pop-up window (FIG. 15) or list. In this example there is no need to add any intelligence, just the pop-up screen. The user may tap the “combo” button 1210 to reveal possible combo's or window combinations such as in a pop-up window (FIG. 16) or list. Again, no need to add any intelligence, just select from the pop-up screen.

As shown in FIG. 17, once added the windows 1708-1714 reside in room layout area 1704 and the number of windows (4), such as shown in FIG. 10 and in the list 1702 of FIG. 17 automatically increment to match. The window detail list 1702 at the bottom of screen 1700 details fields based on the add-window selection process. The data is automatically reflected in appropriate fields of each of the screens including the house screen of FIG. 10. As shown in FIG. 17, the room layout area 1704 may include indicia of exposure or relative location and positioning of the room and the windows relative to the house, e.g., front, back, side, such as by use of a check-box (front/back) in the panel. A previously added photo or picture, either of the image or of the room, may be represented or accessible from the screen 1700 either by way of tapping the window icons in area 1704 or by tapping the “visualize” button on list 1702.

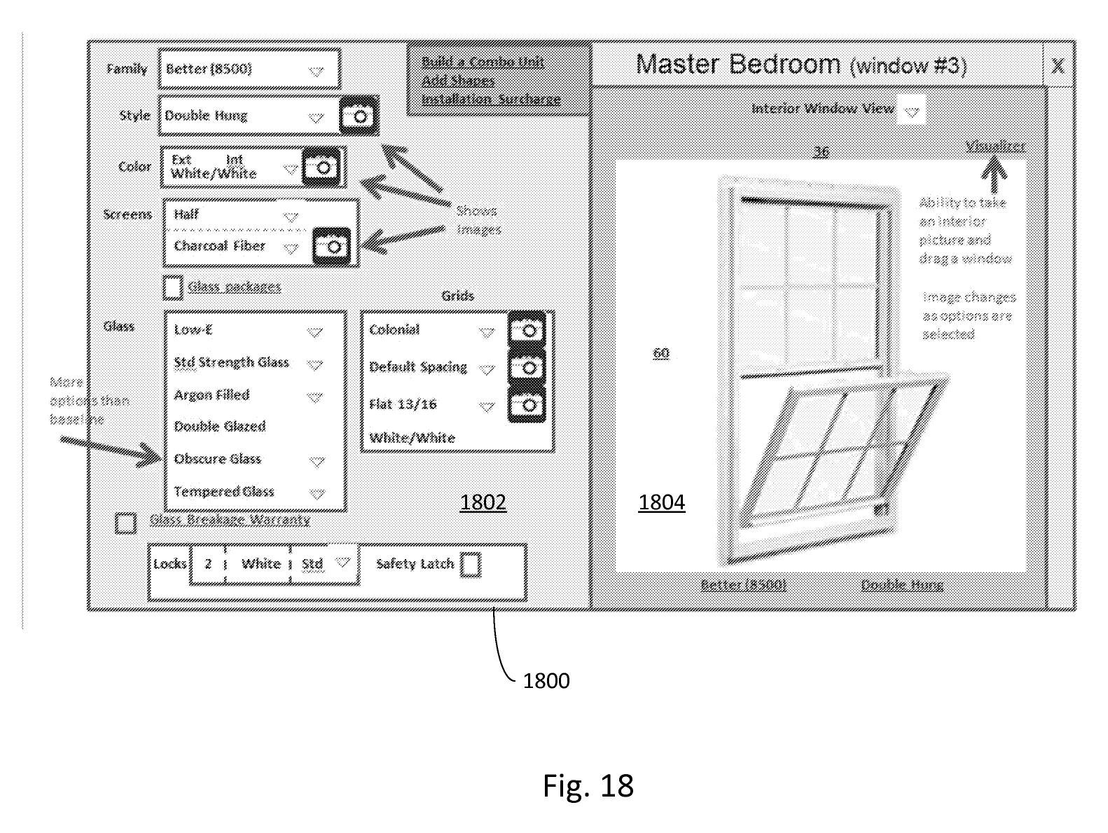

In this manner, when a virtual replacement window is placed in the virtual room during the collection process, it will start life as a “baseline” window. The salesperson will have the ability to present the homeowner with modifications or upgrades to the baseline window. In addition, the system provides users with the ability to customize a particular window (or opening) or to add windows or other features, e.g., add transom, add bay window, add garden window, add sidelights, add hardware, add upgrade in style, etc. If a window needs a minor adjustment or modification such as to the frame or to replace surrounding wood or other building elements separate from the replacement window, the user may call up a window customizer interface screen that resembles the baseline window interface screen. One difference is that additional options will become available (tempered; obscure) because these selections present more effectively as individual windows and not as a default for the house. An additional customization is “mulling/joining” two or more windows together to form an architectural element (FIG. 18).

FIG. 18 illustrates a Window Customizer user interface of the SWAT tool. FIG. 18 illustrates an exemplary screen shot of the interface used for the detailed window configurator. This may be similar to the baseline window configurator except it may also include many options that are available—options may depend on size and type of window selected or identified. In one exemplary embodiment, the SWAT tool makes use of an existing solution called RenoWorks, which provides a floating window configurator. Custom windows may be marked as such especially those requiring substantive alteration or repair beyond the replacement of the existing window. As discussed above, some window replacements may be very costly (enlarging an opening, replacing deteriorated wood/materials surrounding window) so the dealer/contractor needs the ability to surcharge. The SWAT tool enables the salesperson to capture this during the survey process and include the cost in any quotes generated following this process.

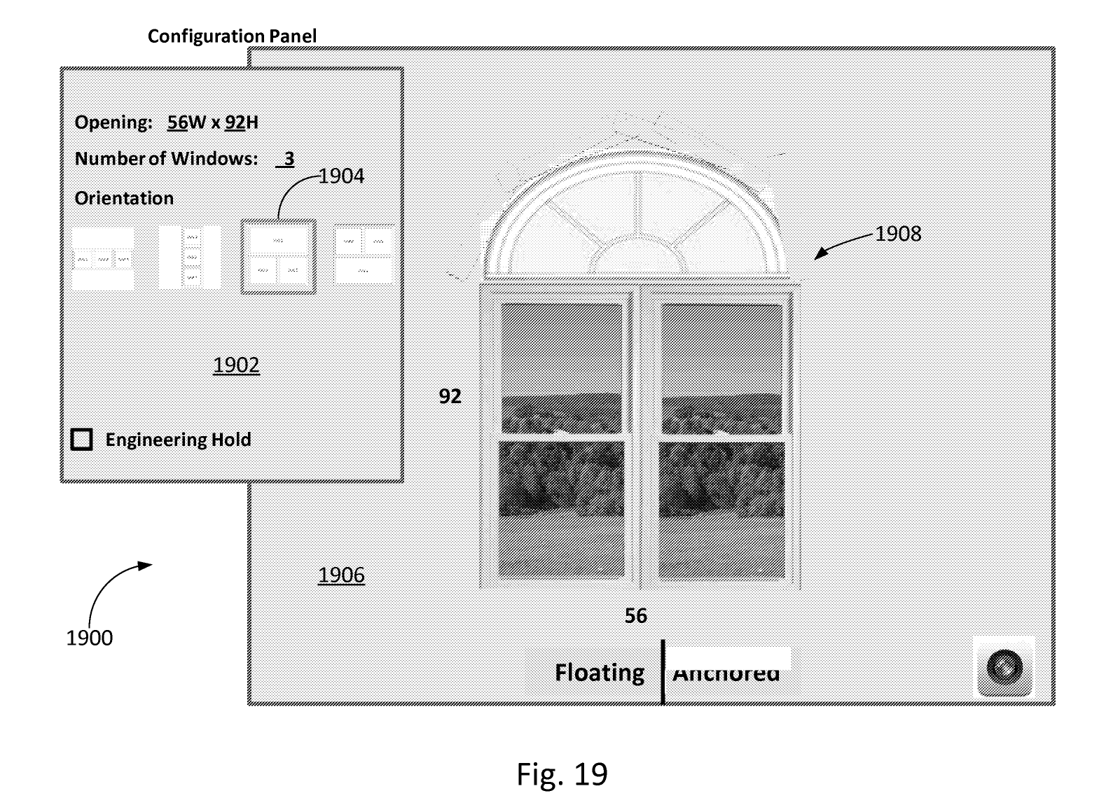

FIG. 19 illustrates a “Multi-Window Customizer/Combo-Unit Floating” interface screen 1900 having a Configuration Panel 1902 in this instance showing a three-window combination 1904 with a collective “Opening: 56W×92H” and “Number of Windows: 3” with a displayed orientation. Next to the configuration panel is a screen portion 1906 having an illustration 1908 of one three-window configuration. This representation is referred to as a “Floating” representation in that it is not fixed or tied to any room or building elements. RenoWorks or similar such application is used to implement this aspect of the tool. Based upon opening size, number of windows, etc., RenoWorks can assist with the drawings. In this manner the user can drag lines to size the windows with respect to one another. Touching an individual window can navigate the user to the window customizer screen.

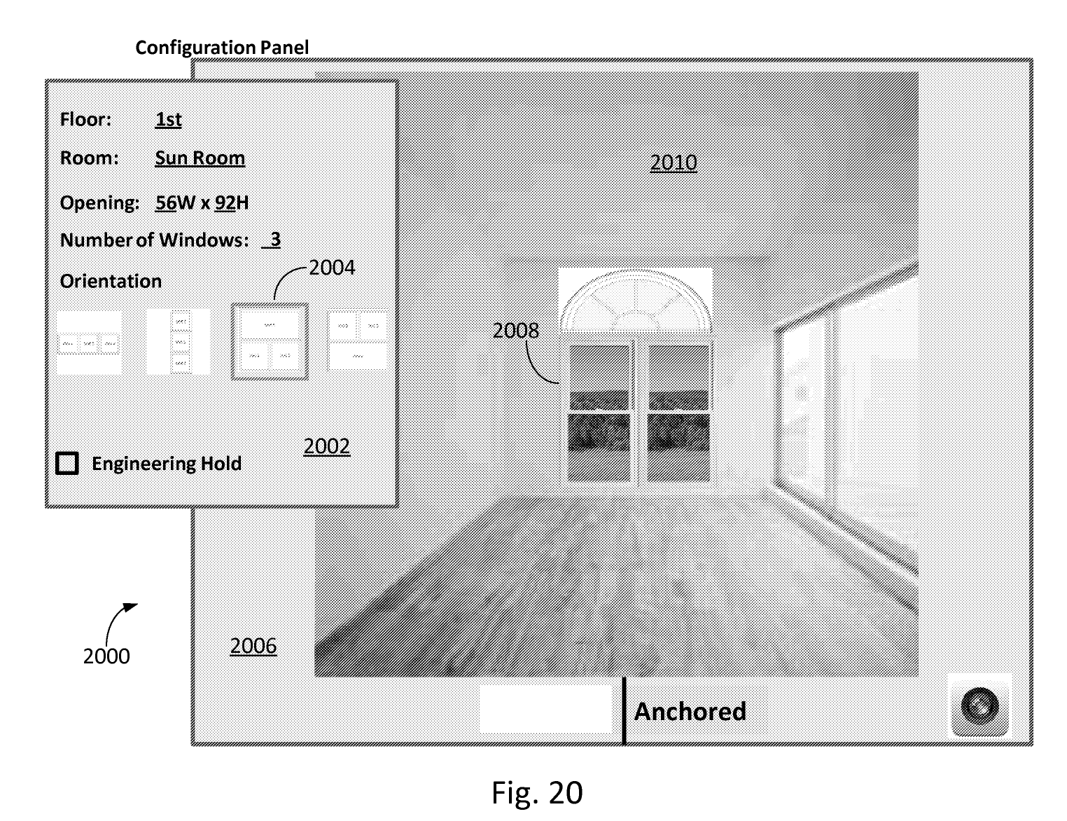

FIG. 20 illustrates a “Multi-Window Customizer/Combo-Unit Anchored” interface screen 2000. FIG. 20 illustrates a “Configuration Panel” 2002 for “Floor: 1st” and “Room: Sun Room” with “Opening: 56W×92H” and “Number of Windows: 3” along with a three-window configuration 2004. Next to the configuration panel is a screen portion 2006 having an illustration 2008 of one three-window configuration. This representation is referred to as an “Anchored” representation in that it is shown fixed or tied to a particular room and wall 2010 with surrounding building elements, e.g., floor, other windows in the room and other elements captured in an image, which may be taken by the salesperson using the camera integrated on the user's device, e.g., iPad. For instance, the salesperson takes a picture of a wall and can then drag a window (even a customized one) over top for visualization. If there are items on the wall, the window will just partially cover them unless the picture is sent for rasterization.

The SWAT tool running on the salesperson's device may also include the following features: a Window Quoter, Quote Summary, Financial Calculator, and Energy Calculator to help the salesperson demonstrate to the homeowner various options and the pay-back associated with different types of replacement windows. With the Financial Calculator, the user can take an existing quote and produce a payment terms sheet (which can be emailed to the home owner). For instance, the parameters may include: Loan Amount=amount from one of the quotes; Interest Rate=comes from a default table for the dealer/contractor; Loan Term=comes from a default table for the dealer/contractor. The Energy Calculator may take into account the following factors: number of windows; Window Sq ft; exposure; annual Energy Cost; local energy cost; condition and efficiency of existing windows being replaced; temperatures and local weather conditions; location of building. These calculations are relatively complex (and will require significant assumptions and fine print), but the majority of the information is captured in the sales call WalkAbout data collection process. The calculation may take into account NFRC (National Fenestration Rating Council) Label or ratings.

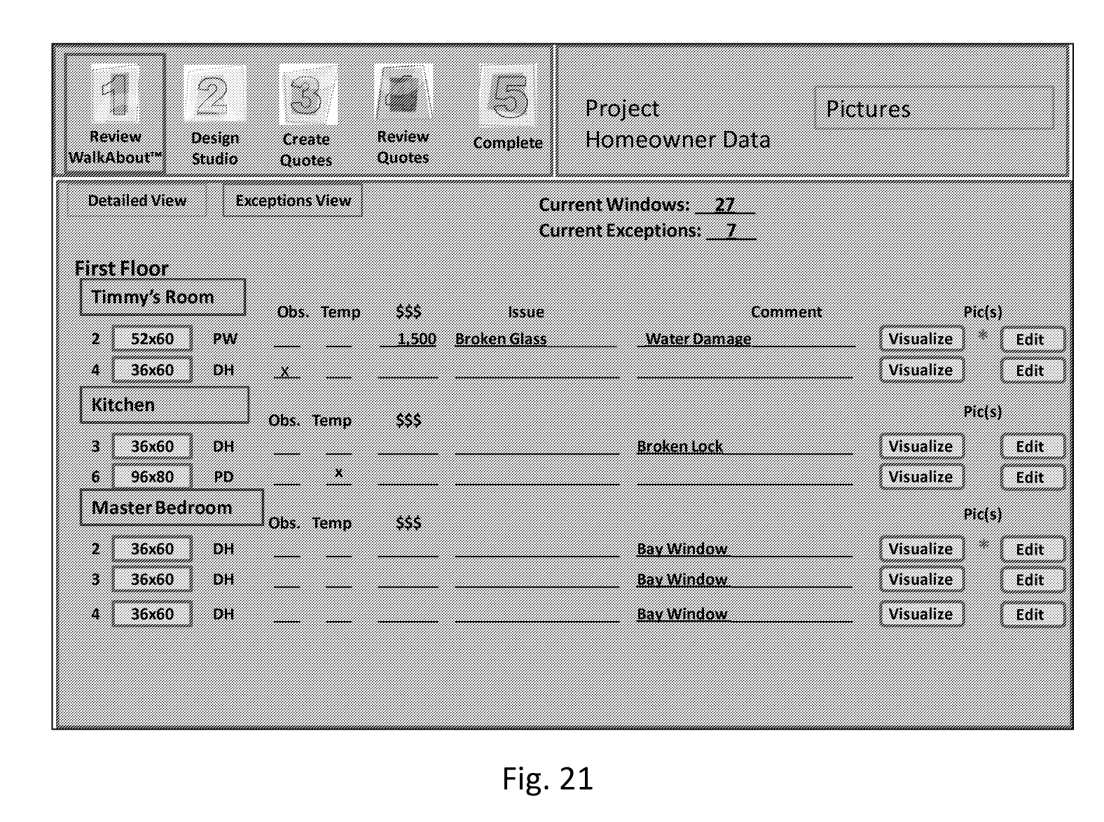

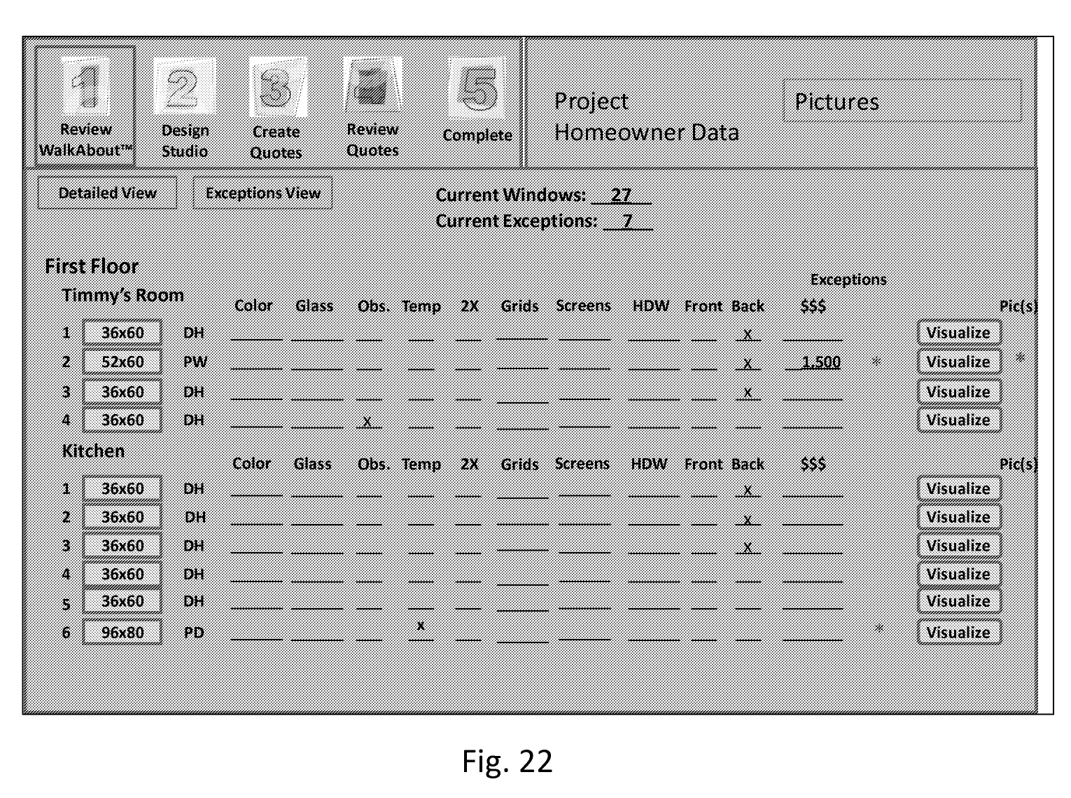

FIGS. 21-22 illustrate interface screens used to review the information captured during the survey walk about with the home owner. The screen may default to the “exceptions” information captured during the survey. In this manner the SWAT tool provides the salesperson with an effective means to walk the home owner through the data captured and the current state of the windows and areas of greater (e.g., broken windows, rotted sills) and lesser needs (faulty seals).

The interface screen of FIG. 21 includes the following tabs: Review WalkAbout (Survey); Design Studio; Create Quotes; Review Quotes; and Complete. Using the Review WalkAbout screen, the sales person discusses with the home owner what was found (e.g., comments and issues previously identified and captured) and how serious the needs are (e.g., broken glass, water damage, broken lock and associated costs) and what the options are for replacing the building elements and/or adding new elements. The salesperson can use these results to help create a need, while the home owner can review the screen to get an idea of the scope of the problem. Preferably this interface screen will represent the particular building subject to the sales call (e.g., floor layout, “Timmy's Room,” Kitchen, Master Bedroom, etc.). From this screen, visualizations, photos or other aids may be presented to enhance the sales experience and increase the likelihood that the building owner will enter into a contract for products and services.

The user may also reference other functions of the SWAT tool. For example, the user may refer back to the education section, e.g., “Window University” of FIG. 9, to provide or revisit information related to windows with the home owner, such as by presenting electronic documents, video and content designed for presentation using the salesperson's mobile device focused.

An “exception” identified during the survey may be anything that the salesperson marks as special and may be entered and represented, for example: obscure glass; double strength glass; issue drop down; free-form comment; picture attached; up-charge for construction, e.g., $ 1,500 broken glass, water damage, multiple windows with broken locks. Exceptions may be any identified non-standard or non-baseline window type, e.g., Bay Window.

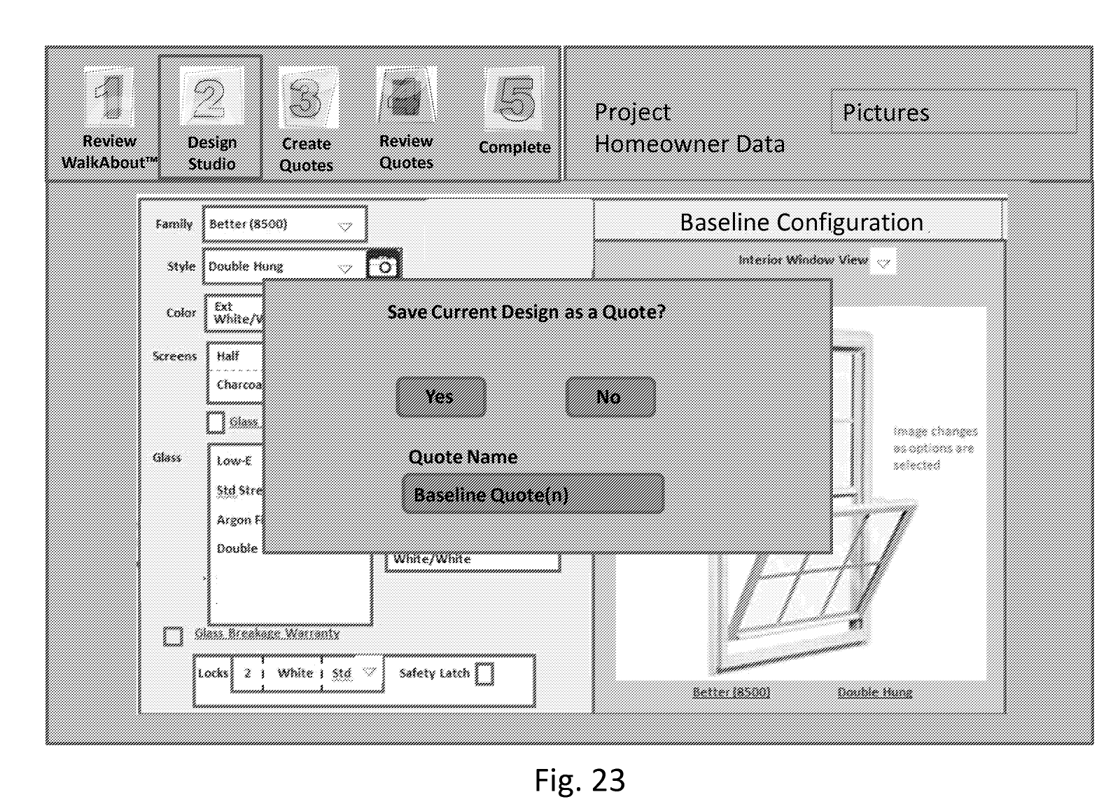

With reference to FIG. 23, the Design Studio tab allows the salesperson to show the home owner what the windows will look like with the options that were selected. Initially, and at the time of the sales call, this visualization may be “floating” (i.e., a window floating in space—before rasterization of photos has occurred). Eventually, the windows may be placed “on the home owner's house” (interior and exterior) post-rasterization. Although rasterization is not required, the visual appearance of the windows is preferably after rasterization.

The salesperson subsequently leaves the Design Studio and goes to “Quotes” tab section. A quote should be presented to the user at the time of the sales call and should match the WalkAbout data collected during the survey. The user may assign the quote a name and see it on the Quotes screen discussed below.

In one embodiment, the visualization aspect relies on a visualization engine, e.g., RenoWorks or the like, that runs native on the salesperson's mobile device (e.g., iPad). Once a user creates a design, the user may then generate a quote based on the design characteristics with pricing. The visualization capability may be used at many times during the sales process, including: during the Window University phase when educating the home owner about windows to show the owner what the various options are; during the WalkAbout phase as an excellent opportunity to make a sale at the opening (e.g., “You have such a beautiful view from this window. Have you ever thought about putting in a bay window?”); while using the Design Studio at the kitchen table to set the baseline for the entire house (series, model, glass package, grids, etc.), the elements that can change in the design studio apply to every window in the home, so it makes sense to exclude options that don't make sense for the whole home (tempered, obscure); while configuring a particular window, or set of windows (e.g., windows in the master bedroom may need wood grain to match the interior, while the rest of the windows will work with standard vinyl).

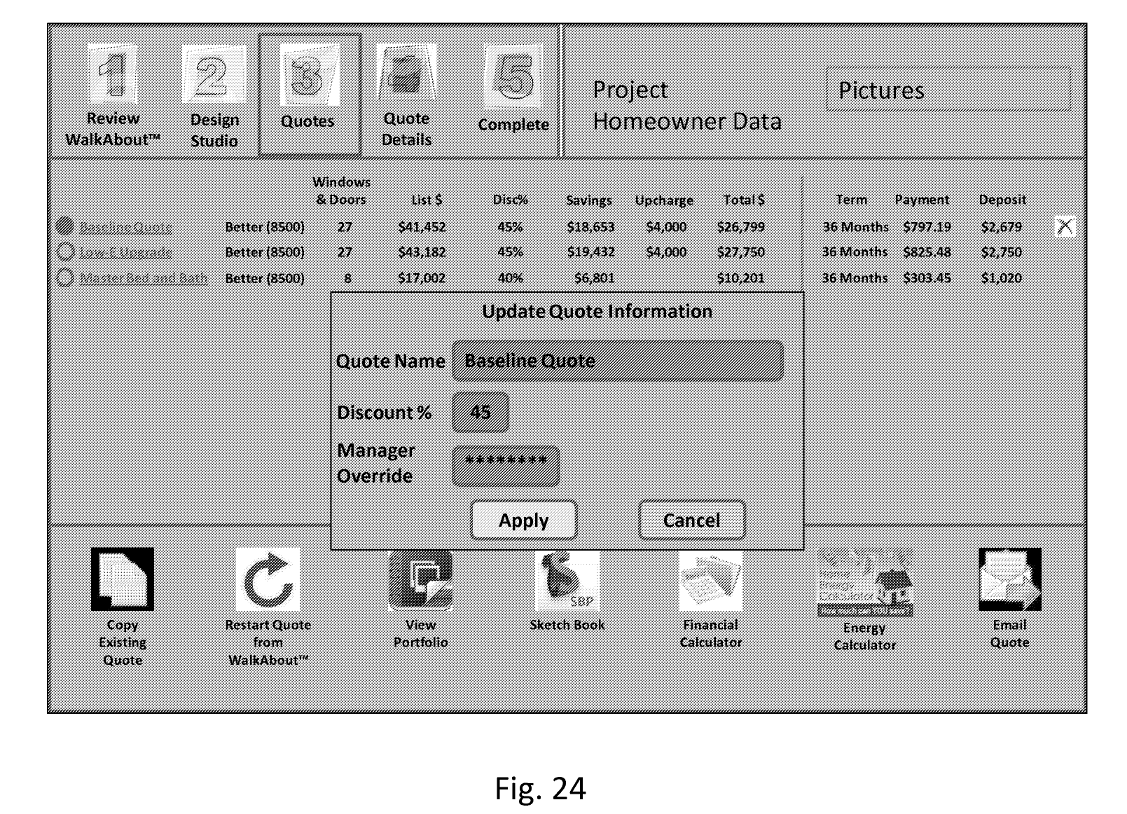

With reference to FIG. 24, the “Quotes” section of the SWAT tool is the hub of the quoting process. It allows a salesperson to easily create multiple quotes originating from the information collected by Walking About. Every time a new quote is created, it becomes the default quote (the radio button is selected for the active quote). Note that new quotes can be derivatives of existing quotes as the home owner may be trying to save money (e.g., “what happens if we drop one grade level or quality level?”) or understanding how much an option will cost for the house (e.g., “what would the low-e glass upgrade cost?”).

The following are examples of user actions that may be used during the sales call. Upon a user tapping on the “Review WalkAbout” tab, the SWAT tool presents the user with the Review WalkAbout screen (exceptions). Upon tapping on “design studio” the user is presented with the “Design Studio” area for the active quote. The salesperson can then modify the options and either update the existing quote or create a new quote. Tapping on the “Quote Details” tab causes the SWAT tool to present the user with a screen that allows them to make individual changes to a particular window for the active quote. Tapping on a URL associated with a quote name allows a user to change the name, add comments, change discount percent and override salesperson %. Tapping “Copy Existing Quote” takes the user to the Design Studio to manipulate options and to create new quotes (this is very similar to tapping on Design Studio). Tapping “Restart Quote from WalkAbout” allows a user to create a new quote from the original project survey data collected during the “Sketch Book” launches a standard sketch program (this may also be part of the Design Studio area). Tapping “Financial Calculator” brings up a financial calculator interface for use by the salesperson during the sales call to present various financing options that may be available to a homeowner. Additional information may be gathered to confirm financing options and connection with a third party financing partner may be an optional aspect of the SWAT tool. Tapping “Energy Calculator” brings up energy savings data for use by the salesperson in showing the customer how much energy may be saved by replacing existing building products and/or with upgrades to baseline products previously selected. Tapping “Email Quote” presents a salesperson with a form or interface to prepare an email from salesperson or dealer with homeowner filled in and a spot for comments. In this manner a salesperson can prepare and send a quote by email to the homeowner along with all pertinent collateral for the items on the quote at the time of the initial sales call.

As shown in the right side of the screen of FIG. 24, a “Financing” area may be displayed. This may be enabled or disabled by the user. The rates and terms for financing may be set to a default. Optionally, discussed above, the SWAT tool may include an interface to facilitate sharing of information with a third-party financing partner to assist in establishing credit and/or in arranging financing to help close a deal with a customer.

In one manner of operation, if a quote has been modified manually (see “Quote Details”), then the “Design Studio” changes preferably are done in a way that does not undo the changes or to make the manual changes invalid. For example: if the windows in the Living Room have been configured with wood grain and then the Design Studio is redone later in the process, the salesperson and home owner have to be notified to verify overwriting of previous manual settings.

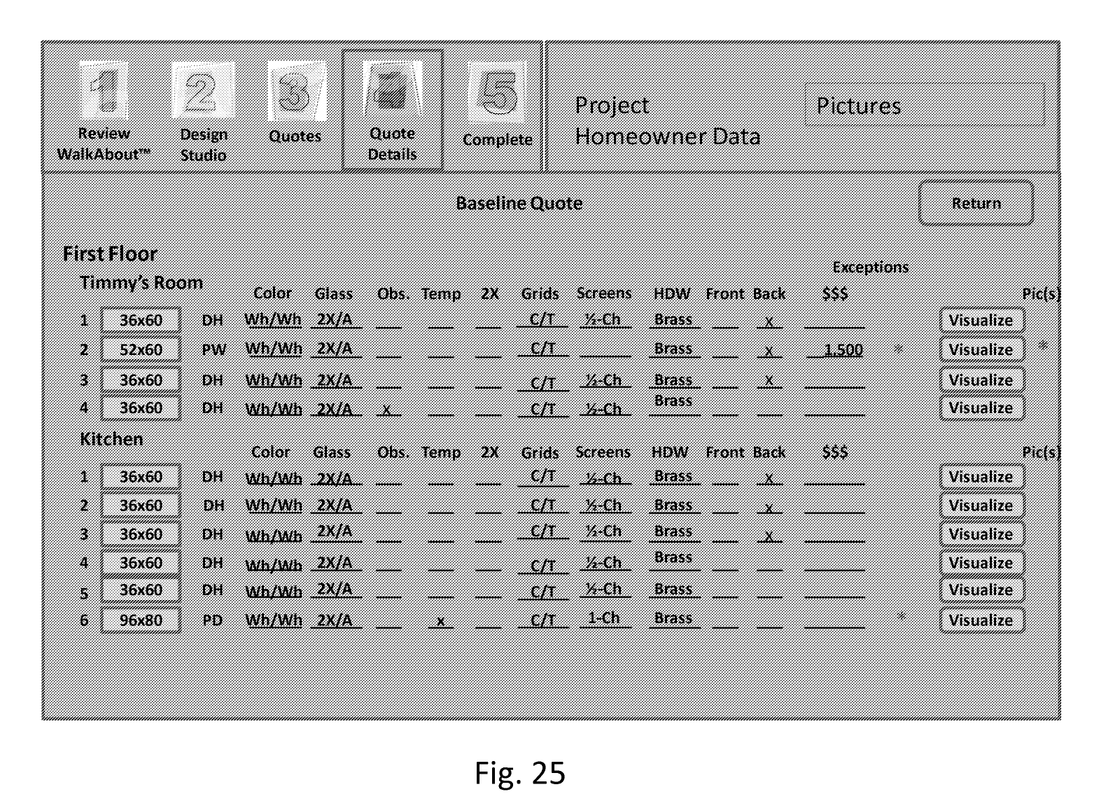

With reference to FIG. 25, the “Quote Details” section of the SWAT tool is where the salesperson goes to do the fine tuning for configuration of a single window (the “Design Studio” is for group changes). The salesperson can also delete windows (actually inactivate them, not delete them). Inactivated windows show up as shaded or grayed-out with the ability to reactivate them. Added windows show up as a light green and can also be inactivated.

The tool may use the House imagery to help the salesperson navigate complex issues typically raised by a home owner during a sales call. The data seen on this screen is from ‘Quote’ data, not WalkAbout survey data. The SWAT tool treats the quote and survey data as separate data sets. For example a home owner may request the salesperson to reduce the cost (the project and quote are too expensive).

The tool allows the user to modify (increase) the discount percent. However, every dealer/contractor will set list pricing and standard discounting for the windows as options. The salesperson may be given a discount range (i.e., from standard discount 45% up to 49%). Anything above that discount range may require manager approval that gets activated via a special code given out by management. The discount pass code may be set in the system as an option by the dealer/contractor administrator. The salesperson can modify or reduce the quality of windows (e.g., go from BEST to BETTER or GOOD) to reduce the cost of the project. The salesperson may reduce the number of options (e.g., less expensive glass package) to reduce the cost of the project. The salesperson may reduce the number of windows (e.g., instead of doing the entire home only do the first floor, or only the front of the house) to reduce the cost of the project. The home owner may ask the salesperson to add options and features and to determine the cost implications and/or energy savings (total and monthly) related to the modification. If energy efficiency is important to the home owner they may want to see how upgrading the windows will affect the cost. The system must be able to support upgrades.

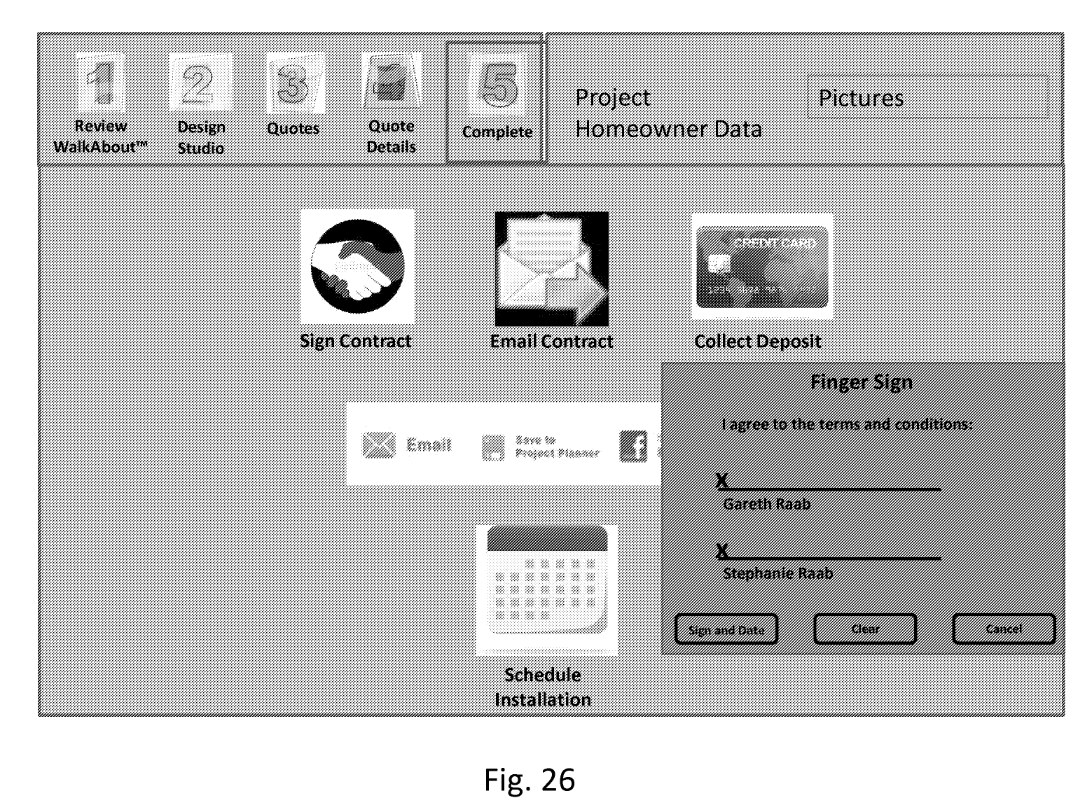

With reference to FIG. 26, the “Complete” section of the SWAT tool shows the steps required to close the deal. The dealer/contractor can either use their current manual process for contract signing or optionally, capture a finger signature on the iPad. The tool can also include an optional credit card or payment collection capability for the down payment.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

We claim:

1. A computer-implemented method for dynamically capturing project data and presenting visualization to a customer using a mobile computing device during an on-site sales visit, the visualization related to captured project data and a prospective building improvement, the method comprising:
a. inputting data representing a description of building elements existing in a building using a user interface operating on the mobile computing device during an on-site survey of the building;
b. storing the input data on the mobile computing device and associating the stored data with a unique project record;
c. generating and presenting a set of one or more visualization images via a display associated with the mobile computing device, the set of one or more visualization images representing a prospective building improvement related at least in part to replacement of one or more existing building elements; and
d. temporally proximate to the on-site survey, generating on-site a firm quotation related to the building improvement and to replacement of one or more existing building elements.

2. The computer-implemented method of claim 1 further comprising:
a. receiving a lead related to a potential sale, assigning a unique identifier associated with the received lead;
b. transmitting a signal to a uniquely identified mobile computing device, the signal related to the received lead and having a unique identifier; and
c. creating by use of the mobile computing device a unique project record associated with the unique identifier.

3. The computer-implemented method of claim 1 further comprising generating a means for executing an agreement and recording an executed agreement related to providing a set of replacement products corresponding to the one or more existing building elements.

4. The computer-implemented method of claim 1 further comprising generating an electronic communication comprising content related to replacement products corresponding to the building improvement.

5. The computer-implemented method of claim 1 further comprising generating a graphical representation of a building associated with the building improvement and existing building elements.

6. The computer-implemented method of claim 1 wherein generating and presenting a set of one or more visualization images comprises presenting a rasterized image representing an aspect of the customer building and presenting the rasterized image with a set of one or more building products in place of or in addition to the one or more existing building elements.

7. The computer-implemented method of claim 1 wherein generating and presenting a set of one or more visualization images comprises presenting at least one of a floating image or an anchored image of a replacement product selected as a prospective replacement for one or more existing building elements.

8. The computer-implemented method of claim 7 further comprising automatically modifying the at least one of a floating image or an anchored image to reflect a user selection altering an aspect of the replacement product.

9. The computer-implemented method of claim 1 wherein the firm quotation relates to a first cost associated with the building improvement and further comprising using the mobile computing device during the on-site sales visit and automatically generating at least one other firm quotation representing a second cost associated with the building improvement and based on a modification of replacement products, and contemporaneously presenting the at least one other firm quotation.

10. The computer-implemented method of claim 1 wherein inputting data representing a description of building elements existing in a building comprises presenting a default set of sizes related to building elements for use in inputting data, the default set of parameters related to previously input data representing a description of building elements existing in a building using during the on-site survey of the building.

11. The computer-implemented method of claim 1 further comprising making the set of one or more visualization images related to the building improvement accessible for display via one or more social media sites.

12. The computer-implemented method of claim 1 further comprising processing an electronic payment during the on-site sales visit as payment related to the building improvement.

13. The computer-implemented method of claim 1 further comprising presenting information pertaining to the building improvement during the on-site sales visit, the presented information comprising one or more of the following: educational information relating to replacement building products for use in the building improvement; educational information about product performance characteristics; information about savings or other benefits associated with building products and/or potential payback data; information pertaining to the dealer/contractor and/or installer involved in the building improvement; information pertaining to a sales pitch book; information pertaining to product comparisons; and information pertaining to financing options relating to the building improvement.

14. A computer-based system comprising:
a central server having a processor for executing instructions, a memory for storing instructions, a database containing information related to replacement products or building improvement services, and a communications interface for communicating remotely with field deployed machines;
a mobile computing device having a processor for executing instructions, a memory for storing instructions and data, a display for presenting information, and a user interface for processing inputs related to displayed information, the mobile computing device having a communications interface for connecting remotely with the central server via a communications network; and
a sales walk about tool (SWAT) comprising instructions when executed by the mobile computing device processor adapted to:
a) present a user interface for receiving a set of survey input data representing a description of building elements existing in a building during an on-site survey of the building;
b) store the set of survey input data on the mobile computing device memory and associate the stored data with a unique project record; and
c) generate a firm quotation related to providing services or replacement products corresponding to the existing building elements.

15. The computer-implemented system of claim 14 wherein the central server further comprises:
an input adapted to receive lead information related to a potential sale; and
an output adapted to transmit a signal over a communications network to the mobile computing device, the signal related to the received lead information and an assigned unique identifier and associated unique project record.

16. The computer-implemented system of claim 14 wherein the sales walk about tool (SWAT) comprises instructions when executed by the mobile computing device processor adapted to execute an agreement and record an executed agreement related to providing a set of replacement products corresponding to the one or more existing building elements.

17. The computer-implemented system of claim 14 further comprising means for generating and transmitting an electronic communication comprising content related to replacement products corresponding to the building improvement.

18. The computer-implemented system of claim 14 wherein the sales walk about tool (SWAT) comprises instructions when executed by the mobile computing device processor adapted to generate a graphical representation of a building associated with the building improvement and existing building elements.

19. The computer-implemented system of claim 14 wherein the set of one or more visualization images comprises a rasterized image representing an aspect of the customer building combined with a set of one or more replacement products.

20. The computer-implemented system of claim 14 wherein the set of one or more visualization images comprises at least one of a floating image or an anchored image of a replacement product selected as a prospective replacement for one or more existing building elements.

21. The computer-implemented system of claim 20 further comprising means for automatically modifying the at least one of a floating image or an anchored image to reflect a user selection altering an aspect of the replacement product.

22. The computer-implemented system of claim 14 wherein the firm quotation relates to a first cost associated with the building improvement and further comprising means for generating at least one other firm quotation representing a second cost associated with the building improvement and based on a modification of replacement products.

23. The computer-implemented system of claim 14 further comprising means for presenting a default set of parameters related to building elements for use in inputting data, the default set of sizes related to previously input data representing a description of building elements existing in a building using during the on-site survey of the building.

24. The computer-implemented system of claim 14 further comprising means for making the set of one or more visualization images related to the building improvement accessible for display via one or more social media sites.

25. The computer-implemented system of claim 14 further comprising means for processing an electronic payment during the on-site sales visit as payment related to the building improvement.

26. The computer-implemented system of claim 14 further comprising means for presenting information pertaining to the building improvement during the on-site sales visit, the presented information comprising one or more of the following: educational information relating to replacement building products for use in the building improvement; educational information about product performance characteristics; information about savings or other benefits associated with building products and/or potential payback data; information pertaining to the dealer/contractor and/or installer involved in the building improvement; information pertaining to a sales pitch book; information pertaining to product comparisons; and information pertaining to financing options relating to the building improvement.
